(19) United States
(12) Patent Application Publication
(10) Pub. No.: US 2003/0172198 A1
(43) Pub. Date: Sep. 11, 2003

(54) Workload playback for a system for performance testing of N-tiered computer systems using recording and playback of workloads

(76) Inventors: Ashutosh Tiwary, Bothell, WA (US); Przemyslaw Pardyak, Seattle, WA (US); Tavis D. Elliott, Bothell, WA (US); Anthony A. Hutchinson, Seattle, WA (US)

Correspondence Address: PERKINS COIE LLP, PATENT-SEA, P.O. BOX 1247, SEATTLE, WA, 98111-1247, US

(21) Appl. No.: 10/372,019

(22) Filed: Feb. 21, 2003

Related U.S. Application Data
(60) Provisional application No. 60/358,989, filed on Feb. 21, 2002.
(60) Provisional application No. 60/417,021, filed on Oct. 7, 2002.

(51) Int. Cl. G06F 3/00

(52) U.S. Cl. 710/1

(57) ABSTRACT

A facility for playing back live workload data in a N-tiered computing system executing a group of application programs is described. The facility retrieves live workload data identifying a set of recorded requests and their arguments that have been received during an earlier recording period in a particular order by a specified application program among the group of application programs. The facility presents each request identified by the retrieved live workload data to the specified application with its arguments to play back the requests identified by the retrieved live workload. The played-back requests are presented in the same order as the recorded requests were received during the recording period and with the same arguments with which the recorded requests were received during the recording period. Such presentation preserves the semantic correctness of the application and preserves the performance accuracy of the N-tiered system in which the identified requests were received.

### CROSS-REFERENCE TO RELATED APPLICATIONS

This application claims the benefit of U.S. Provisional Application No. 60/358,989, entitled “REAL-WORKLOAD CAPTURE AND REPLAY TECHNOLOGY FOR ACCURATE LOAD AND PERFORMANCE TESTING,” filed on Feb. 21, 2002 and U.S. Provisional Application No. 60/417,021, entitled “REAL WORKLOAD PERFORMANCE ANALYSIS,” filed on Oct. 7, 2002 and is related to U.S. Patent Application No. ______, entitled “INSTRUMENTATION AND WORKLOAD RECORDING FOR A SYSTEM FOR PERFORMANCE TESTING OF N-TIERED COMPUTER SYSTEMS USING RECORDING AND PLAYBACK OF WORKLOADS,” filed concurrently herewith (Attorney Docket No. 360058003US) and U.S. Patent Application No. ______, entitled “WORKLOAD POST-PROCESSING AND PARAMETERIZATION FOR A SYSTEM FOR PERFORMANCE TESTING OF N-TIERED COMPUTER SYSTEMS USING RECORDING AND PLAYBACK OF WORKLOADS,” filed concurrently herewith (Attorney Docket No. 360058007US), all four of which applications are incorporated herein by reference in their entirety.

### FIELD OF APPLICATION

The present system relates to performance testing, and, more specifically, to the performance testing of N-tiered computer systems.

### BACKGROUND

An N-tiered computing system divides functionality into one or more partitions, also called tiers. In some cases, each tier comprises some identifiable functional component of the overall system. The tiers may be organized roughly following the processing flow in the system. In some other cases, all functionality is placed in a single software entity or tier. Each tier can be distributed onto one or more computers, connected by a network. In other cases, two or more tiers can be deployed onto a single computer. In yet other cases, tiered functionality can be distributed between multiple processors of a single computer. In complex systems, functionality is distributed between several computers, connected by a network, with each computer having one or more processors. The functionality in any one tier can be either stateful or stateless. While examples discussed hereafter generally refer to a commonly used three-tier architecture, the discussion of N-tiered systems herein is equally applicable to computing systems: using any number of tiers.

It can be important to measure the performance of such systems for many different reasons, including diagnosing and resolving complex performance problems, predicting the performance of the system under different load, and predicting the performance of the system under different hardware and software configurations.

The performance measurement of complex N-tiered computer systems has traditionally proven to be difficult. Two broad classes of approaches have been applied to the problem of measuring the performance of N-tiered systems: reproducing the performance characteristics of a live system in a more controlled testing or staging environment, and monitoring of system performance in online or live systems. The former allows for more detailed exploration and analysis using an experimental approach, while the latter approach provides for a more statistical analysis of live data. The most common approach to reproducing performance characteristics of a live system is to externally apply a synthetic workload to the system under test. Externally-applied synthetic workloads cannot stimulate internal system interfaces in the same ways as can workloads resulting from real usage of the application. Creating synthetic workloads to stimulate the many interfaces within the system in the same way as a real application workload can be a daunting task, requiring a deep understanding of the complex inner workings of the system as well as a detailed understanding of how the application is really used under live conditions.

Some performance measurement systems create a synthetic workload, which is applied to the N-tiered system under test. Synthetic workloads often simulate real usage of the application by building a script that represents a single user usage scenario and then running that script n times to simulate usage of the system by n users. Such a script or program can either be developed by a programmer that writes the code for it, or by recording a single user's usage of the system and then automatically generating the script from the recorded information. Before a script can be executed n times to simulate the data and timing characteristics of n users, the script must be modified in order to add parameters to the script. In this way, any number of unique requests can be created and applied to the system under test according to desired timing characteristics. Unfortunately, this approach cannot reliably create a realistic workload since only one or a few actual recorded sessions or purely synthetically generated scripts are used as the basis for the entire workload. These limitations make it difficult to produce a workload that is realistic in terms of request variety and timing characteristics when compared to a system in a live environment. Further, creating synthetic workloads for internal interfaces is quite difficult.

Some performance measurement systems attempt to monitor activity of a live N-tiered system, also called a production N-tiered system. These performance measurement systems measure various system performance metrics on the live system, and can record performance metrics for requests and responses at both internal and external interfaces. These performance measurement systems typically use various analysis methods to determine the performance characteristics of the system under test. These performance measurement systems do not attempt to create a workload for later playback in order to reproduce the performance characteristics of the live system. Therefore, an experimental exploration of a performance problem or alternative fixes to improve the performance under identical conditions is difficult.

In view of the foregoing, a performance measurement system that both utilizes a realistic workload in a live system and facilitates measuring the performance of a number of different system configurations under that same workload would have significant utility.

### BRIEF DESCRIPTION OF THE DRAWINGS

FIG. 1 is an overall block diagram showing components of one possible embodiment of the data recording and playback system.

FIG. 2 is a tree diagram showing a taxonomy of instrumentation techniques used in some embodiments.

FIG. 3 is a flow diagram showing the fixed interface installation process used in some embodiments.

FIG. 4 is a simplified diagram of a class, method and interface map used in some embodiments.

FIGS. 5A and 5B are flow diagrams showing a simplified view of the byte code offline instrumentation installation process used in some embodiments.

FIGS. 6A and 6B are flow diagrams showing a simplified byte code online instrumentation installation process used in some embodiments.

FIG. 7 is a data flow diagram showing simplified data recording entity relationships used in some embodiments.

FIGS. 8A, 8B and 8C are flow diagrams showing a simplified view of a byte code workload capture process used in some embodiments.

FIGS. 9A and 9B are flow diagrams showing a simplified view of a workload recording process used in some embodiments.

FIGS. 10A-10I are graphs showing experimentally-recorded overhead measurements.

FIGS. 11A and 11B are flow diagrams showing a simplified view of a byte code workload post-processing process-used in some embodiments.

FIGS. 12A and 12B are flow diagrams showing a simplified view of a fixed interface workload post-processing process used in some embodiments.

FIG. 13 is a simplified block diagram showing components of a playback agent used in some embodiments.

FIGS. 14A and 14B are flow diagrams showing a simplified view of a workload playback process used in some embodiments.

FIGS. 15A-15O are graphs showing experimentally-measured performance accuracy data.

### DETAILED DESCRIPTION

The following description refers to the accompanying drawings, and describes exemplary embodiments of the present system. Those skilled in the art will recognize that other embodiments are possible, and that modifications may be made to the exemplary embodiments without departing from the spirit, functionality or scope of the system. It is also noted that many aspects of the system-as well as many subsets of the aspects of the system-have independent utility, and may be gainfully used in the absence of the other aspects of the system. Accordingly, the following discussion should not be construed to limit the spirit, functionality or scope of the system.

Overview

A data recording and playback system (“the system”) is provided. Embodiments of the system overcome deficiencies of conventional performance testing and monitoring systems by performing both live data recording and playback of live and synthetic workloads for performance measurement of N-tiered computer systems. The system makes use of both internal and external instrumentation techniques to record live requests, responses to such requests, and state information for the system under test. Arguments for both live requests and responses are also recorded. The performance measurement system uses the recorded information, possibly augmented with additional data, to create a workload for playback. The requests comprising the workload are then played back on the system under test, and the responses, along with the arguments to the responses, are recorded and analyzed.

The live or production N-tiered system under test can be subject to one or more—possibly concurrent—requests. The system under test processes the requests and typically returns one or more responses. Requests can originate from a number of sources, including human users or automated processes. Requests can be expressed in any type of command message, request for information, function call or transaction request. Requests can be processed entirely within the N-tiered system under test, or using one or more external systems, data sources, processes, or services. In some N-tiered systems, requests are processed asynchronously. In these cases, the time required to return a response can depend on the load on the various interfaces within the N-tiered system under test, processing requirements, processing latency for external requests, and amount of data required to be transferred to create the response. Because of this asynchronous processing, responses can be received in any order relative to requests. The contents or arguments of some requests depend on information returned as responses to previous requests. In these cases, even if the processing in the N-tiered system under test is asynchronous, the subsequent requests are synchronous relative to the receipt of previous responses.

In some cases, requests to the N-tiered system under test are organized into defined sessions, where one or more (possibly related) requests and responses are exchanged between the N-tiered system under test and external users or automated processes. In some cases, a session can be comprised of any sequence of requests during a period of time when the user or automated process is logged in, possibly over a secure connection. In other cases, the session can be a sequence of requests and responses comprising one or more transactions. In yet other cases, a session can be any set of related or unrelated requests and responses between a user or automated process and the N-tiered system under test. Within the recording and playback system data can be divided into units of work. A unit of work can comprise any convenient partitioning of the workload including a single request and response; multiple, possibly related, requests and responses; or one or more sessions.

The data recording and playback system is designed to maximize the flexibility of measurement from both external interfaces and internal interfaces. External interfaces include those with well-defined Application Program Interfaces (APIs). Internal interfaces may include the functions or methods of the application that may not be externally declared or visible and are only available in the source code or the byte code of the application. Thus, the instrumentation can record and play back data at any internal or external interface in the N-tiered system under test. The instrumentation is used to record one or more (possibly concurrent) requests and responses, including their arguments, at any interfaces for the N-tiered system under test. The instrumentation supports the concurrent recording and playback of data at multiple different external and internal interfaces simultaneously, possibly in a distributed environment. Thus, the instrumentation allows the recording of workloads and performance data and the playback of the workload for N-tiered systems under test of virtually any architecture. The tiers of the N-tiered system under test may be in one or more physical locations connected by one or more networks. The tiers of the N-tiered system under test may be comprised of one or more processors in a cluster or multiprocessor systems, such as Symmetric Multiprocessor systems. Further, the communications between the tiers can be either tightly or loosely coupled.

The data recording and playback system can assemble one or more recorded requests and transactions into a workload. Appropriate modifications or transformations are applied to parameters in the workload to parameterize the workload. This parameterization process ensures that the records used for playback match the state of the system. In addition, parameterization can be used to create a greater variety of requests, and to vary the timing and other user-specific or application-specific parameters of the requests in the workload. Finally, such workload manipulation also enables synthetically-generated records to be added to the workload.

The data recording and playback system can combine or partition workloads. Both live recorded data records and synthetic data records can be combined as required to create various workload streams to support any level of required throughput, number of sessions, duration of playback, and other such workload properties for the system under test. Large workloads can be partitioned to create a smaller workload or to create several concurrent loads that can be played back by several servers to create higher throughput rates than a single server may be able to achieve. Combined or partitioned workloads can be parameterized to create unique records and sessions in the workload, maintain agreement with system state, and to match the throughput and timing requirements for the workload playback.

The data recording and playback system can present a workload with a desired level of throughput at any external or internal interface on the N-tiered system under test. Throughput can be measured in a number of ways including the rate at which requests are presented per period of time, the number of active concurrent users per unit of time, the number of active sessions per unit of time or the units of work performed per period of time. By scaling the workload, the system is able to present a workload with the desired level of throughput. Workloads can be scaled in a number of ways. For example, time dilatation (to increase and decrease the rate at which requests are played back) can be applied to a given workload to achieve different throughput levels. As another example, several workloads can be played back concurrently to create larger workloads.

The data recording and playback system can restore the required state for the system under test prior to a playback experiment. This capability ensures that system responses produced during playback semantically agree with the original capture of the requests and accurately reproduce the system performance characteristics of the original system under the original workload. The system keeps track of two kinds of system state: the static state of the system that existed before the workload capture was initiated, and the dynamic state of the system that is established during the execution of the workload. Both static and dynamic system state can be captured and restored. Static state, such as, database state, is captured before the workload is recorded and can be restored before playback begins. Dynamic state, including connections and processes, is captured while the workload recording is in progress can be restored while playback is in progress.

The data recording and playback system can measure the performance of the system under test. The recording and playback system can use a number of metrics to measure the performance for the N-tiered system under test including, throughput rates, thread lifetimes, CPU loads, response times and network loads. These measurement capabilities may be used to measure various aspects of performance for the system under test at any number of desired workload levels. The performance accuracy of the system under test, during playback, may be determined by comparing the performance metrics captured during playback with those recorded during live data capture. At the same time, these measurements can be used to determine the overhead imposed by instrumentation, by measuring performance with and without the instrumentation installed or activated, for example.

Facilities are provided to measure the semantic correctness of workload playback on the system under test. To accomplish this, both requests and responses are recorded during playback. The responses, including arguments, can then be compared with those recorded on the live system to determine the correctness of the playback experiment.

The data recording and playback system can provide error processing or error handling capabilities. Errors can result from any number of causes, including mismatch between the actual system state and the state assumed in the workload, an application or data source not being available to the system under test, or a request being placed before other prerequisite requests have completed. When an error is detected, the data recording and playback system can take any one of a number of actions including: continue processing with or without corrective action; abandon the session or unit of work causing the error; or abandon the playback experiment all together.

System Overview

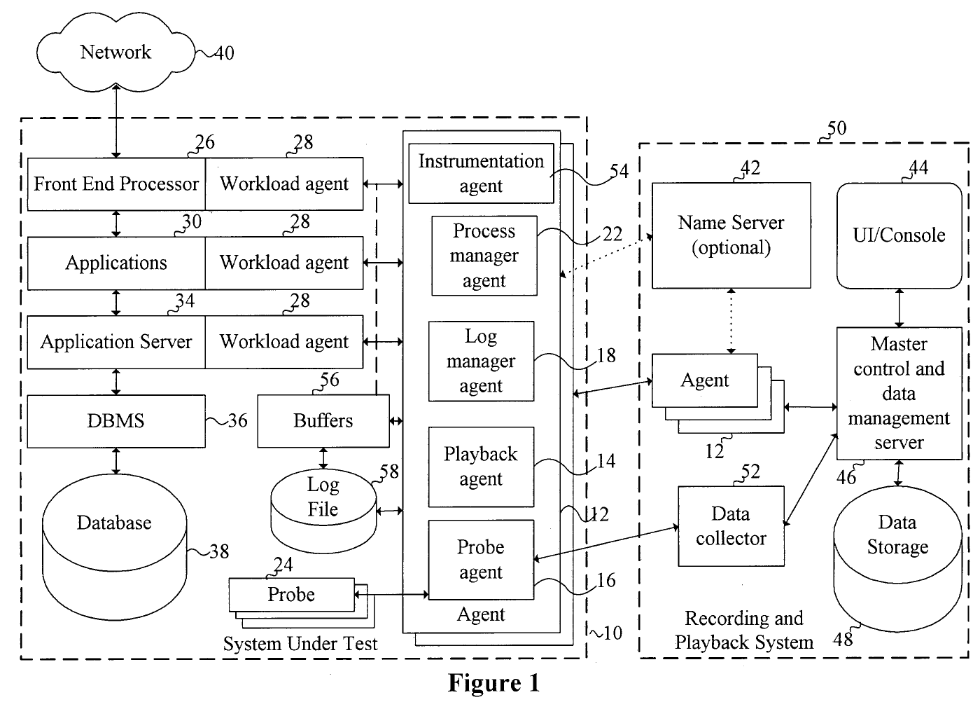

FIG. 1 is an overall block diagram showing components of one possible embodiment of the data recording and playback system. The overall system is comprised of a system under test 10 and a recording and playback system 50. The system under test and the recording and playback system can be distributed among one or more computer systems. These one or more computer systems can be connected by any combination of local area networks and wide area networks. In some embodiments, the system under test and the recording and playback system will be placed on different computer systems, or segregated by processor on a multiprocessor system, to limit the overhead of recording or playback affecting the performance of the system under test. In other embodiments, these components can be on the same one or more computer systems as the system under test. In some embodiments, live data is recorded on one system under test and played back on a different, and possibly differently configured, system under test (e.g., a production system and a test system).

The system under test 10 is comprised of one or more functionally segregated tiers (N-tiers). These tiers can run on the same computer system, run on one or more distributed computer system, and can run on multiple processors or one or more single or multi-processor computer systems. The physical distribution and functionality of the tiers is determined by the architecture of the system under test. The examples given here are only to illustrate the application of the system to some of the common architectures, but virtually any architecture can be accommodated, and thus the examples are not intended to limit the scope, functionality or sprit of the data recording and playback system. As an example, a typical three-tiered application is illustrated.

One or more front-end processors 26 in a first tier receive requests from users or automated systems and present results back to those same entities. The requests and results are often transmitted over one or more data networks 40. Some applications will use a Hypertext Transport Protocol (HTTP) servers as front-end processors. Well-known examples of commercially available HTTP servers supporting N-tiered architectures include the Internet Information Server (IIS) from Microsoft Corporation or the Apache server and its commercial derivatives. In other cases, the front-end processors may execute one or more proprietary or applications specific protocols. Those skilled in the art will be familiar with the techniques, architectures and protocols used by these front-end processors in N-tiered application environments.

In a second tier, one or more applications 30 perform the required processing for the requests received at the front-end processors with the assistance of one or more application servers. The applications can be written in one or more of the any suitable compiled or interpreted programming languages. Examples of commonly used suitable languages include Java, C, C++, C#, Cobol, Fortran, Smalltalk, Visual Basic, Pascal, Ada, Structured Query Language (SQL), and Perl. The applications in the second tier use the services of the one or more application servers 34, to perform computing tasks such as authentication, transaction management, etc. Well-known examples of commercially available application servers supporting N-tiered architectures include the Java 2 Enterprise Edition (J2EE) platform, the Microsoft Transaction Server (MTS) and the Common Object Request Broker Architecture (CORBA). Those skilled in the art will be familiar with the techniques, architectures, and protocols used to apply these platforms in N-tiered application environments.

In a third tier, data and records used by the application are typically managed by one or more Database Management Systems 36 (DBMSs), and are stored in one or more databases 38 in some suitable type of nonvolatile memory. Well-known examples of commercially available DBMSs include the Oracle DBMS from Oracle Corporation, the SQL Server DBMS from Microsoft Corporation and the DB2 DBMS from IBM. Those skilled in the art will be familiar with the techniques, architectures, and protocols used to apply these DBMSs in N-tiered application environments.

One or more agents 12 manage the recording and playback of data records on the system under test 10. The agents are self-contained functional units and may comprise both executable code and stored data. The agents may themselves be composed of one or more agents. One or more playback agents 14 manage the playback of workloads. One or more log manager agents 18 collect data records, aggregate the recorded data, possibly compressing, and encrypting it, and transferring the data in bulk to the data recording and playback system 50. One or more process manager agents 22 control the creation, invocation, and shutdown of process on the system under test during recording and playback. Process manager agents can start processes, terminate unused processes and ensure that required processes remain operating during either recording or playback. One or more instrumentation agents 54 control the instrumentation on the system under test 10. One or more probe agents 16 collect and record system metric data for the system under test and transfer this data to the data recording and playback system.

Workload agents 28 are typically deployed on each tier of the N-tiered system under test 10. The workload agents manage the buffers 56 used by the instrumentation in each tier. The workload agent collects and possibly compresses the recorded data placed in the buffers by the instrumentation agents, and transfers this data to a log file 58.

A master control and data management server 46 in the data recording and playback system 50 has overall control of the data recording and playback processes. Users interact with the system through a User Interface (UI) Console 44. Recorded data and workloads for playback are stored in a data storage 48. An optional name server 42 assists other components of the system in locating each other in a distributed or networked environment. A data collector 52 manages the collection of system performance or metric data, transmitted by the probe agent 16, for the system under test 10. Agent 12 on the data recording and playback system has the same structure and functionality as the agent on the system under test already described.

The one or more tiers of the N-tiered system under test 10 are instrumented to facilitate the recording and playback of request and response data. The instrumentation may be distributed in any manner throughout the tiers of the N-tiered system under test. Recorded data is typically captured in the form of a record, which includes the request information or response information for a particular interface or internal component of the system under test. The arguments for both the request and response are also recorded. In addition, other information such as timing information, resource utilization information, threading information and locking information may also be recorded for each request. The instrumentation can record data or play back a workload either internally or externally to any tier of the system under test. In a typical configuration, one or more workload agents 28 collect data from the tiers of the system under test, under the control of the workload capture agent 54. In some embodiments, the collected data is stored in real-time into one or more temporary buffers 56 and periodically transferred to one or more log files 58. The buffering process can reduce the instrumentation overhead in the system under test by limiting the I/O to the log files in nonvolatile memory. The buffer memory can also be compressed and encrypted as described in greater detail below. At the end of the data recording process, the one or more log manager agents 18 transfer the log file contents to the data recording and playback system 50. The exact number, nature and placement of the workload agents and associated instrumentation is determined by the architecture, configuration, performance characteristics and functionality of the system under test. Some examples of instrumentation techniques used by embodiments of the system include:

1. Plug-ins or other add-on modules for any of the tiers of the N-tiered system, which typically exploit an API exposed by the tier or an application executing in the tier. For example, a plug-in can be used to record requests and responses in a front-end processor 26 HTTP server.

2. Source code-level instrumentation on any of the tiers of the N-tiered system, where the programming language used has a suitable supporting structure. Source code instrumentation can be applied at either the calling side or called side of a function or method invocation.

3. Byte code level instrumentation on any of the tiers of the N-tiered system, where the programming language used has a suitable supporting structure. Byte code instrumentation can be applied at either the calling side or called side of a function or method invocation.

4. Object code level instrumentation on any of the tiers of the N-tiered system. Object code instrumentation can be applied at either the calling side or called side of a function or method request.

5. A monitor in the data path between tiers of the N-tiered system, where the agents typically monitor or inject data onto networks 40 used to connect the tiers of the N-tiered system.

The one or more playback agents 14 can play back a workload. The workload is typically transferred to the system under test 10 before playback begins, but the workload may be read from a remote location, or the playback agents may themselves be run from machines outside the system under test. The playback agents can dispatch the requests in the workload to one or more buffers where the records are queued and can be serviced by one or more playback threads during the playback process.

One or more probes 24 measure system or application level metrics on the various components of the system under test. The one or more probe agents 16 capture, record and transfer data from the probes in real-time. In some embodiments, the real-time data is used to assess instrumentation overhead and system performance for the N-tiered system under test. The exact number, nature and placement of the probes is determined by the architecture, configuration, system capabilities and performance characteristics of the system under test. Some examples of probes that can be used for the system under test can include:

1. Counters in computer operating systems, network 40 infrastructure, front-end processors 26 such as HTTP servers, applications servers 34 and DBMSs 36 can collect information on the activity of these components during a test.

2. Other measurements from the computer operating systems or other sources for quantities, which can include start time and end time for threads, system date and time, sessions or connections, Central Processing Unit (CPU) utilization and memory utilization.

Static system and application state is typically captured before or after workload recording. Dynamic system and application state is typically captured before and during the data recording process. This captured state information is used to restore any important system state before data playback. Both dynamic and static state restoration may be required to produce responses that are semantically correct and exhibit the required performance accuracy when recorded requests are played back. Static system state can include database state and other initial application or system state. Dynamic state can include the transaction or session identifiers, number of active requests or threads, number of processes running, the number of open connections and the number of open file descriptors.

At the conclusion of data recording, or possibly at certain times during a recording session, the one or more log manager agents 18 on the system under test 10 transfer recorded data from the log file 58 to one or more agents 12 on the data recording and playback system 50. These agents then pass the data to the master control and data management server 46, where it is stored in the data storage 48. These agents 12 on the data recording and playback system have the same structure as those agents 12 on the system under test 10 described above.

In many cases, post-processing steps are performed to prepare the recorded workload for playback. The master control and data management server 46 typically performs these post-processing steps on the recorded workload in the data storage 48. The server orders the data records and other measurements so that request and response records from each interface of the N-tiered system under test 10 are correlated in time. Parameterization and transformation is performed as necessary, and the workload is scaled to create the required units of work to prepare the workload for playback. Workload post-processing is described in greater detail below. The server then organizes the recorded data records into one or more workloads. The workloads are stored in the nonvolatile data storage 48 and transferred to the playback agent 14 on the system under test 10.

The one or more probe agents 16 collect information on system metrics for the system under test 10. Data collected from the one or more probes is passed to the one or more probe agents 16 which, in turn, pass the data to one or more data collectors 52, possibly in real-time. The data collectors aggregate the system metric data and pass it to the master control and data management server 46 for archiving in the data storage 48.

The system provides one or more User Interfaces (UI) or consoles 44 to allow user to control data recording and playback functions. User specification of instrumentation and other data recording and playback functions is typically performed through the UI. The UI allows users to monitor the performance accuracy, semantic correctness, instrumentation overhead and system performance metrics during both recording and playback sessions. The master control and data management server 46 supplies the UI with the real-time performance metric and overhead data for the system under test 10 during data recording or playback. Users can use the UI to manage sets of recorded data and playback workloads in the data storage 48.

The agents 12 and 28, probes 24 and master control and data management server 46 use the optional name server 42 to locate one another on the one or more computers comprising the system under test 10 and the data recording and playback system 50. When agents and servers initialize, they locate the name server and register themselves. The agents and servers can then request and receive location information on other agents with which they must communicate. In alternative embodiments, the agents can use fixed names or network addresses or names and network addresses that obviate this registration process. In other cases, the agents can use peer-to-peer protocols to locate each other. In yet other embodiments, agents can use some combination of automatic and manually supplied information to locate each other.

The architecture using agents 12 and 28 and probes 24 described above is not intended to indicate the only possible embodiments. The functional divisions indicated are merely meant to clarify various functions of the system. The functionality of the agents and probes can be combined in any manner desired. For example, the workload capture agent 28, instrumentation agent 54, log manager agent 18 and the playback agent 14 can be combined into one or more integrated agents. In another example, the one or more probes 24 and probe agents 16 can be combined into integrated entities. In yet another example, the functionality of the agents 12 can be integrated into the master control and data management server 46. The master control and data management server could then work with one or more client programs on the system under test 10, where the client programs have the minimal functionality required. In yet another embodiment, the functionality of some, or all, of the name server 42, the UI 44 and the master control and data management server 46 could be integrated into the agents. In some embodiments, the functionality can be distributed between a set of agents, which communicate and interact with each other on a peer-to-peer basis, eliminating the servers.

Overview of Instrumentation

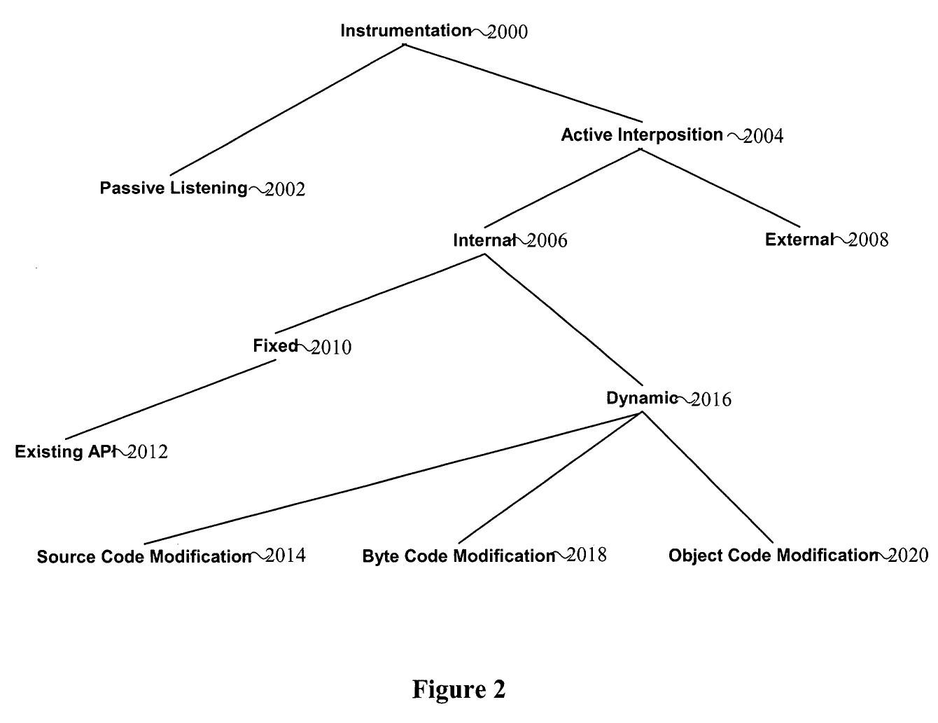

Data recording processes use instrumentation installed on the system under test 10. Several types of instrumentation can be used, depending on the interface being instrumented. In some embodiments, the one or more workload capture agents 28 record the data from the instrumentation. FIG. 2 is a tree diagram showing a taxonomy of instrumentation techniques used in some embodiments. In some embodiments, instrumentation 2000 is divided into two broad classes: passive listening instrumentation 2002 and active interposition instrumentation 2004.

With passive listening instrumentation 2002, data is directly recorded by snooping on the messages at an accessible external system interface on the system under test 10. In one possible example, messages transmitted and received over an interface with a network 40 are recorded. In this example, the messages recorded can be from an HTTP session transmitted over a network between a user and the HTTP server front-end processor 26. Alternatively, the messages could be in encoded in the XML language and transmitted between the tiers of the N-tiered system or between the front-end processor and other, external, processors connected to a network. In another possible example, a workload agent 28 subscribes to a server with event notification capabilities for data and requests passing through the system. The workload agent listens for these events and records the messages that it was notified about. In some cases, the recorded messages are encrypted or otherwise specially encoded, and may need to be decrypted or decoded before other processing can continue.

With interposition instrumentation for active recording 2004, data and requests being transmitted through an interface are intercepted and recorded, and the execution of the request is continued. External interposition instrumentation 2008 records data at externally published interfaces of the system under test 10 or using a published public communication protocol. As an example of external interposition, a proxy server is used to intercept, record and forward messages transmitted over socket connections between tiers of the N-tiered system under test, or between the system and other external processes communicating over a network 40. In some cases, the recorded messages are encrypted or otherwise specially encoded, and may need to be decrypted or decoded before other processing can continue. At the same time, the workload may need to be encrypted or encoded before or during playback.

Internal interposition instrumentation 2006 intercepts, records and continues the execution of requests and data transmitted through internal interfaces in the system under test 10. In general, these interfaces are internal to the tiers of the N-tiered system. Internal interposition instrumentation can operate in a fixed manner 2010 or a dynamic manner 2016. In most cases, messages traversing these internal interfaces will not be encrypted at the entry to the interface or the exit from the interfaces, because the encryption or decryption happens at layers prior to the interfaces.

Fixed internal interposition instrumentation 2010 operates by using an existing API for a component or tier of the system under test 10 that provides for a way to intercept, record, and then continue the execution of requests and data 2012. For example, the HTTP workload instrumentation and capture module uses the ISAPI or NSAPI interfaces for web servers to install a plug-in that will intercept and record both the request and the responses and the data associated with the requests and responses.

Dynamic internal instrumentation 2016 does not require a predefined externally accessible interface. Instead, it can instrument any set of interfaces, classes, or methods internal to an application and is installed through the modification of program code in the system under test 10. Code modification can be at any level including source code, byte code or object code.

Instrumentation can be added through the modification of source code 2014. In one possible form of source code modification instrumentation, once the instrumentation points are identified in the source code of the application, instrumentation code is installed which intercepts each request flowing through the interface and copies the requests, responses, and data traversing an interface, which are recorded by a workload agent 28.

In other possible embodiments, byte code modification instrumentation 2018 is employed. Once the instrumentation points are identified in the byte code of the application, instrumentation code is installed which intercepts each request flowing through the interface and copies the requests, responses, and data traversing an interface, which are recorded by a workload agent 28. The installation and use of byte code instrumentation is discussed in greater detail below.

In some embodiments, object code modification instrumentation 2020 can be applied. Once the instrumentation points are identified in the binary representation of the application, instrumentation code is installed which intercepts each request flowing through the interface and copies the requests, responses, and data traversing an interface, which are recorded by a workload agent 28. [0063]. In some embodiments, external instrumentation is applied to measure loosely coupled distributed systems. In many cases, these types of systems use messaging protocols for communications between the components, and therefore have well-defined interfaces or APIs and use well defined communication protocols. Thus, external or fixed interface instrumentation is generally suitable for these types of systems. As an example, systems following the several defined or emerging web services standards use well defined messaging specifications to communicate between a plurality of loosely coupled components or services. In some web services based systems the interfaces are defined as a set of Extensible Markup Language (XML) schemas, which are transported over Simple Object Access Protocol (SOAP) connection. The fixed instrumentation can record the requests and responses using the SOAP protocol to these interfaces.

Fixed Interface Instrumentation

Instrumentation and workload agents 28 can be installed on tiers of the N-tiered system under test 10 with fixed interfaces or defined APIs. An HTTP front-end processor 26 is an example of a tier with a fixed API that can be used for instrumentation purposes. The instrumentation for the front-end server or other server with a fixed interface can be comprised of plug-ins or other probes or libraries added to the server, used to capture requests and responses. Such a plug-in, probe, or library is typically custom-built for each such interface where the request and responses need to be recorded. Some interfaces provides the capability to correlate the request and the response so that both can be recorded as related. One technique for recording requests and responses that has a very low impact on the response time of the request is to use the capability in the server to register a callback routine, which is invoked by the server when the server processes each request, and/or when it generates each response. In some embodiments, the plug-in records some minimal information about the request in a data structure that is attached to the request, and returns from the callback to the server. When a response is processed, the callback is invoked after the response has been sent by the HTTP front-end processor and the plug-in processes the response asynchronously. Several popular HTTP servers support this callback technique, for example. Other techniques involve tracking a request identifier, a thread identifier or a session identifier. In other cases, the server may use an event notification model or announcement model to notify the capture module when a request is processed, or a response to a request is processed. These alternative techniques are particularly useful where the server does not support callback techniques.

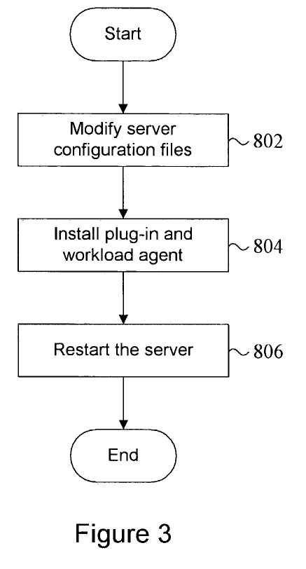

FIG. 3 is a flow diagram showing the fixed interface installation process used in some embodiments. It will be understood by those skilled in the art that the particular sequences of steps shown in FIG. 3 and the other flow diagrams discussed below are merely exemplary, in that the order of steps can be changed, additional steps added or steps removed without changing the functionality, scope of spirit of the system. Further, steps shown as being executed in series may be executed in parallel, or vice versa. Steps executed in parallel may be executed by different threads, processes, processors, or computer systems.

In step 802, the master control and data management server 46 connects to the instrumentation agent 54, which makes the required configuration changes in the server configuration files. In step 804, the instrumentation agent installs the plug-in and the workload agent 28. In step 806, the instrumentation agent restarts the server to activate the plug-in. After step 806, the server is ready for data recording and these steps conclude.

Class, Method and Argument Maps

In some embodiments, a map for relating classes, methods, interfaces and argument types is used. This map may be created through automatic analysis of source code, byte code or object code for the system under test 10. The resulting map is analogous to a symbol table created by a linker, but is generally more complex and contains more detailed information. The class, method and interface map describes a static mapping of what classes are related to each other by usage, derivation and inheritance, what methods are called from which classes and methods and the interfaces and interface types. In some embodiments, the map is constructed from a single-pass static analysis of the application code. The system uses the map to determine which classes and methods to instrument to match a particular instrumentation expression and what areas of the code to examine to instrument for a given expression, and to determine the number and type of arguments so that the appropriate instrumentation code and stub code may be generated for recording the arguments.

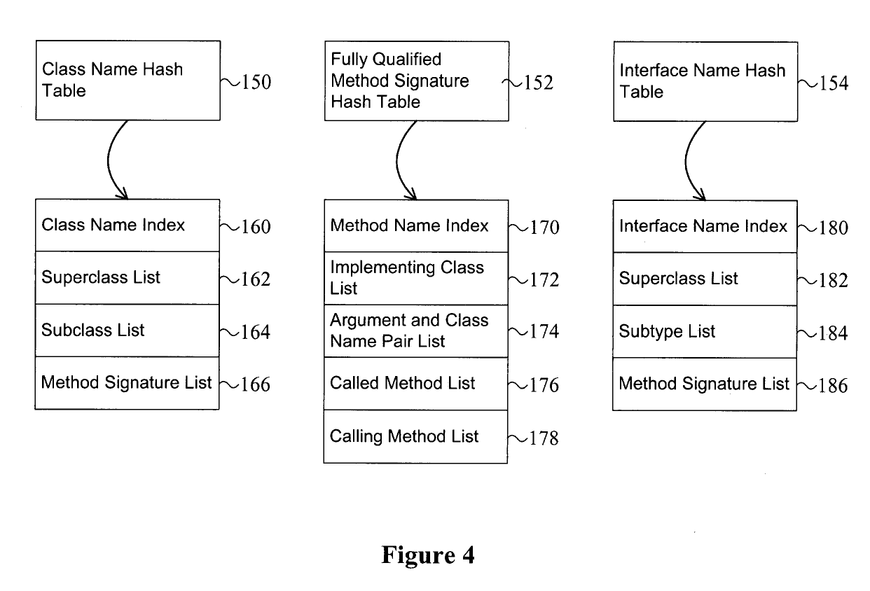

FIG. 4 is a simplified diagram of a class, method and interface map used in some embodiments. It will be understood that other embodiments can use different map structures, yet still achieve the same or similar functionality. For example, the structure of the map may be changed to reflect the type of programming language or languages used for implementing the application used in the system under test 10. Similarly, the structure of the map may be changed depending on the type of instrumentation (source code instrumentation, byte code instrumentation or object code instrumentation) being used to instrument the application used in the system under test 10.

Hash tables 150, 152 and 154 are used to efficiently and rapidly index class names, fully qualified method signatures and interface names, respectively. These hash tables translate between the fully qualified names for the classes, methods and interfaces and an index for the class names 160, method names 170 and interface names 180, and provide entry points to the other information in the table. Under each class name index, the superclasses 162, subclasses 164 and method signatures 166 used by the class are listed. Under each method name index, the list of classes implementing the method 172, the arguments and argument class name pairs 174, the called methods 176 and the calling methods 178 are listed. Under each interface name index, the superclasses 182, subclasses 184 and method signatures 186 for the interface are listed.

Once the map is created, the data recording and playback system can rapidly determine the relationships between classes, methods and interfaces. Further, interfaces to be instrumented can be rapidly identified and their properties determined (i.e., arguments and argument types). For example, if the name of a class is encountered in the byte code, the system uses the class name hash table 150 to find the class name index 160. Given this index, the system can determine the superclasses 162, subclasses 164 and methods used 166 for that class. As another example, given the name of a method, the system can find the method name's index 170 by looking in the method name hash table 152. Given the index, the system can then determine the classes implementing the method 172, the arguments and their classes 174, the methods called by this method 176 and the methods calling this method 178. Thus, once the class and method map has been built for an application, the instrumentation agent can rapidly instrument the application for a given instrumentation specification. Instrumentation Specification Language

In some embodiments, an instrumentation specification language is used to describe what portions of an application should be instrumented and how the instrumentation should be applied. The specification language specifies what to instrument, what to capture, and where to insert the instrumentation. The instrumentation specification is compiled into an instrumentation implementation data structure which is used to modify source code, byte code, or object code. The specification is typically comprised of three parts:

1. a set of code matching expressions identifying the portions of the code to instrument in an application;

2. a set of instrumentation description expressions describing what instrumentation to insert at the identified point; and

3. a set of instrumentation insertion expressions describing where to insert the instrumentation with respect to the identified point.

In some embodiments, a user specifies each of these instrumentation specification language components. In other embodiments, one or more of the elements provided by default depending on the type and level of instrumentation being performed.

In some embodiments, the code matching expression is defined using a suitable regular expression language. In some other embodiments the instrumentation description expression is defined using any suitable regular expression language. In other embodiments, the instrumentation description expression is comprised of a library of predefined calls that can be used to capture different aspects of request and data flow through one or more types of interfaces. In yet other embodiments, the instrumentation insertion expression is a set of predefined tags that identify where the instrumentation should be inserted (e.g., before or after a call, beginning of the program, end of the program, etc.). The instrumentation insertion expression is also used to specify whether the instrumentation is inserted into the caller or the called side of a request.

As an example, an entry of the instrumentation specification using the instrumentation specification language can have the structure:

X;Y;Z;

where X is the code matching expression (CME), Y is the instrumentation description expression (IDE), and Z is the instrumentation insertion expression (IIE). As a further example these expressions could take forms such as:

Java.sql.*; Capture(ObjectID, methodID, Arguments, entry-timestamp, entry-system-resource-usage); Tag_Before_Statement; where:

1. the value of X is “Java.sql.*”, which specifies that all calls made in the application that start with “Java.sql.” are to be instrumented;

2. the value of Y is “Capture(ObjectID, methodID, Arguments, entry-time-stamp, entry-system-resource-usage)”, which substitutes the appropriate values for the ObjectID, methodID and Arguments depending on the call being instrumented, and inserts a set of code (source code, byte code or object code depending on the type of instrumentation being performed) to capture the specified information, in this case arguments to the Capture statement; and

3. the value of Z is “Tag_Before_Statement”, which specifies that instrumentation for the specification above should be inserted just before the occurrence of each call that starts with “Java.sql.”.

In some cases, other values of Y can be employed besides “Capture”. For example, statements such as “Get_Time”, “Set_Value”, etc. can be employed. Other values of the tagging statement could include:

1. Tag_After_Statement, which specifies that instrumentation for the specification above should be inserted just after the occurrence of each specified call;

2. Tag_In_Main, which specifies that instrumentation for the specification above should be inserted in the main program or method of the application;

3. Tag_At_Beginning_Of_Procedure, which specifies that instrumentation for the specification above should be inserted at the beginning of a specified procedure;

4. Tag_At_End_Of_Procedure, which specifies that instrumentation for the specification above should be inserted at the end of a specified procedure; or,

5. Tag_In_Exception, which specifies that instrumentation for the specification above should be inserted in the exception handling code for the code to be instrumented.

Offline Byte Code Instrumentation

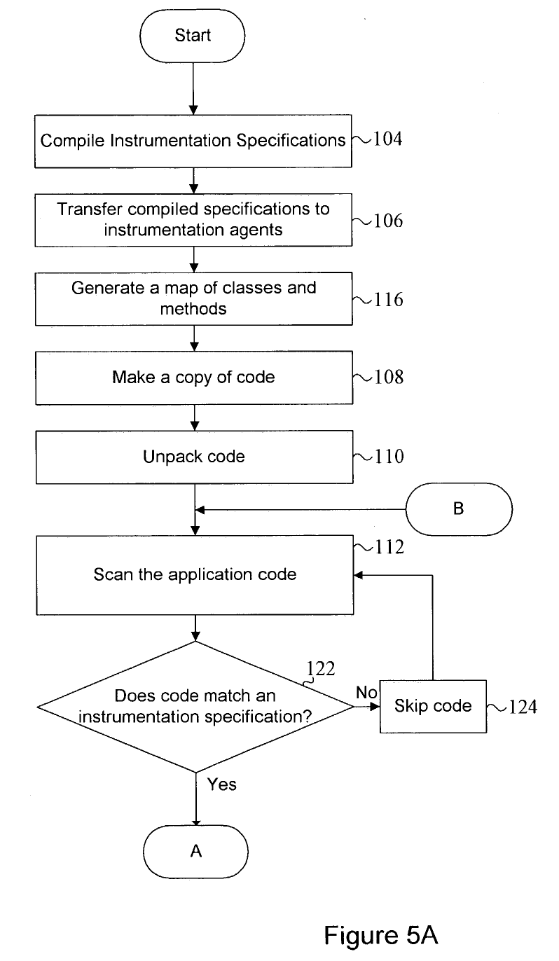

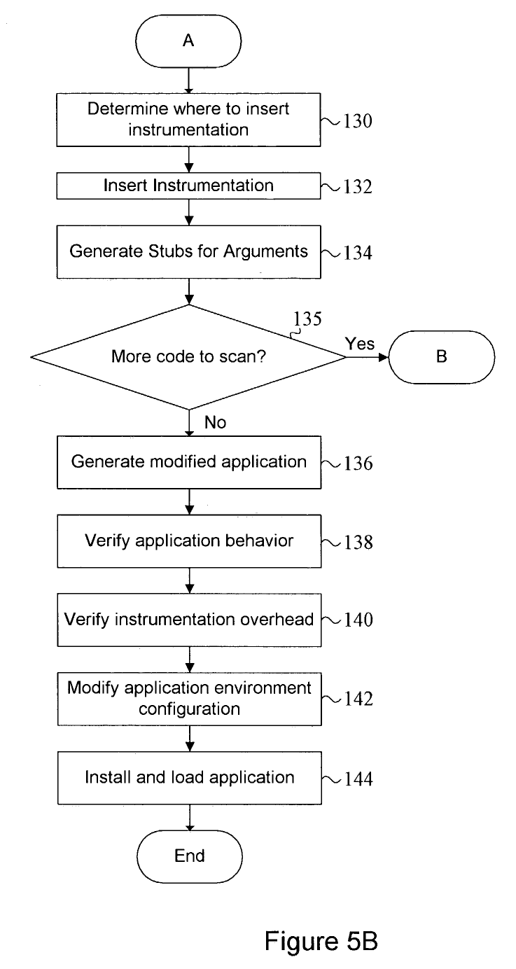

Byte code instrumentation can be installed into the application code for the system under test 10 offline. Once the instrumented code has been satisfactorily verified for correct behavior, it can be installed into the target environment for the system under test. FIGS. 5A and 5B are flow diagrams showing a simplified view of the byte code offline instrumentation installation process used in some embodiments.

The system can specify the instrumentation for the system under test 10. A language used to specify instrumentation is described above. Once the specification is completed, in step 104, the system compiles the instrumentation specifications. In step 106, the compiled instrumentation specifications are transferred to the instrumentation agents 54. In step 116, the system generates a map of the classes and methods used in the system under test. In step 108, the agents make a copy of the code. In step 110, the agents unpack the code to prepare it for analysis.

The system can produce specifications for the classes and methods that are to be cached during data recording even when workload recording is not in progress. This caching of a method is specified as part of the instrumentation specification described above. An example of such a cached method is a call to method to establish a connection. This could happen before the workload capture is in progress, but it needs to be captured in order to faithfully play back the recorded workload. If this call to establish a connection is not cached and then recorded when the workload capture starts and then reproduced before the playback of the main captured workload, the playback of the main captured workload may attempt to use the connection and fail, since the connection was not established at the time when the playback was occurring. In step 112, the instrumentation agents 54 use this instrumentation specification, along with the unpacked code and the class and method map, to scan the code in small code segments.

In step 122, the agents 54 determine whether the current code segment matches any of the instrumentation specifications. If not, the current segment of code is skipped in step 124 and the next segment of code is scanned in step 112. If the current code segment matches one of the instrumentation specifications, the flow of execution continues through connector A in step 130. In step 130, the agents determine where the specified instrumentation is to be inserted. In step 132, the agents insert the specified instrumentation. In step 134, stubs for the arguments in specified method calls are generated. In step 135, if more code remains to scan, the flow of execution continues through connector B to scan the next code segment in step 112, else the flow of execution continues in step 136.

Once all of the code has been scanned, in step 136, the instrumentation agents 54 generate the modified or instrumented version of the application, including repacking the unpacked code into the appropriate libraries. In step 138, the instrumented application is then verified to see if it behaves correctly (i.e., has functional behavior similar to that of the un-instrumented application) and has acceptable performance characteristics. The verification process is generally manual, and can include tests for semantic correctness such as those described below. Once the correctness of the application has been verified, in step 140, the instrumentation overhead can be measured, if desired, to ensure that it is within acceptable limits. The measurement of instrumentation overhead is discussed below. Since the instrumentation is typically installed in an offline application and not a running one, the verification steps can be performed before the instrumented application is installed, using an offline test environment. Installing the instrumentation involves replacing the original application with an instrumented version of the original application. Since the instrumentation is performed from a backup copy of the application, it is possible for someone to change the original application such that the original and the backup copy of the application are different. The agents utilize a local and global checksum approach to determine difference between the original and backup copy of the application and warn the user of unexpected changes in the application before the instrumented version of the application is installed. In step 142, any necessary environment modifications (e.g., modifying the paths to point to suitable workload capture libraries, identifying individual application instances, etc.) are made to the system under test 10. In step 144, the application is installed and loaded. After step 144, the system under test is ready to record data or collect performance measurements, and these steps conclude.

Online Byte Code Instrumentation

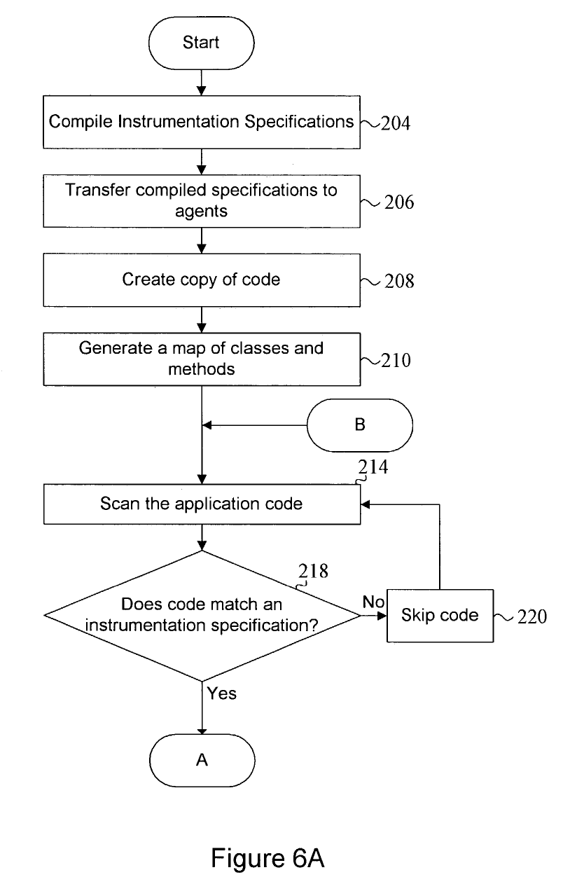

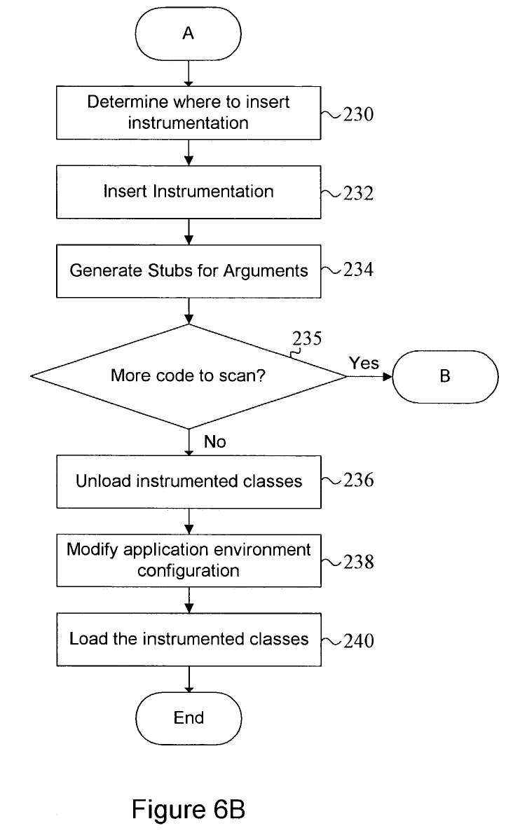

Byte code instrumentation can be installed into the application code when the system under test 10 is online. In this case, the instrumented code is loaded directly into the target environment for the system under test. FIGS. 6A and 6B are flow diagrams showing a simplified byte code online instrumentation installation process used in some embodiments.

The system enables users to specify the instrumentation for the system under test 10. A language used to specify instrumentation is described above. Once the completed instrumentation specifications are available, in step 204, the system compiles the specifications. In step 206, the compiled instrumentation specifications are transferred to the instrumentation agents 54.

In step 208, the system creates a copy of the code. In step 210, the system generates a map of the classes and methods used in the system under test 10. The system can produce specifications for the classes and methods that are to be cached during data recording even when workload recording is not in progress. This caching of a method is specified as part of the instrumentation specification described above. An example of such a cached method is a method call to establish a connection. This could happen before the workload capture is in progress, but it needs to be captured in order to faithfully play back the recorded workload (i.e., play back the recorded workload with semantic correctness and performance accuracy). If this call to establish a connection is not cached and then recorded when the workload capture starts and then reproduced before the playback of the main captured workload, the playback of the workload may attempt to use the connection and fail, since the connection was not established at the time when the playback was occurring. In step 214, the instrumentation agents 54 use this instrumentation specification, along with the instrumentation specifications and the class and method map, to scan the code.

In step 218, the instrumentation agents 54 determine if the current code segment matches any of the instrumentation specifications. If not, in step 220, the current segment of code is skipped and the flow of execution continues in step 214, in which the next segment of code is scanned. If the current code segment matches one of the instrumentation specifications, then the flow of execution continues through connector A in step 230. In step 230, the instrumentation agent 54 determines where the specified instrumentation is to be inserted. In step 232, the instrumentation agent 54 inserts the instrumentation 232. In step 234, stubs for the arguments are generated. In step 235, if there is more code to be scanned, the flow of execution continues through connector B in step 214, in which the next code segment is scanned, else the flow of execution continues in step 236. This process generates a set of instrumented classes and methods to be loaded into the running application.

In step 236, the instrumentation agents 54 unload the classes to be instrumented from the online system under test 10. In step 238, any necessary environment modifications (e.g., modifying the paths to point to suitable workload capture libraries, identifying individual application instances etc.) are made to the system under test. In step 240, the agents load the instrumented classes. After step 240, the instrumented classes and methods are loaded into the application, the system under test is ready to record data or collect performance measurements and these steps conclude.

In some embodiments, byte code modification instrumentation 2018 only makes memory references to the heap and I/O buffers, but not the stack or other system memory. This limitation enables the byte code modification instrumentation to avoid violating runtime security checks and memory access restrictions imposed by many language runtime environments such as the Java Virtual Machine (JVM). In order to record arguments for a method call, the byte code instrumentation pops the arguments from the stack and copies the values onto a memory buffer allocated on the heap, which can then be serialized directly to storage or transferred to an external library to store. In the Java environment, the transfer can use JNI bindings. Once a suitable copy of the arguments is made, the byte code instrumentation pushes the values back on the stack. In other language environments, such as the C++ runtime environment, this limitation is not required. In these cases, the argument values can be copied more efficiently using a pointer reference to the stack frame for the invoked method.

Overview of Workload Recording

Once instrumentation has been installed in the system under test 10, the recording of a workload can commence. The possibly concurrent requests and responses are then recorded at one or more internal and external interfaces on the system under test. In general, byte code instrumentation is used to record requests and responses at internal interfaces. If an external interface such as an API is available, fixed interface instrumentation is typically used.

As the one or more workload agents 28 record the workload, the requests and responses are stored in the buffers 56. Periodically, the data in the buffers can be compressed. The (possibly compressed) data is periodically placed in one or more log files 58. In some cases, the workload to be recorded is larger than the size limit of the file system for the system under test 10. In this case, the workload is divided into a number of different streams, each of which can be stored in a different partition of the file system. Compression and workload stream dividing is discussed in greater detail below.

The system seeks to minimize the overhead imposed by instrumentation on the system under test 10. If the overhead is too great, the performance of the system under test will be adversely affected and the recorded timing characteristics will not be accurate. In many cases, it is desirable to measure and quantify the instrumentation overhead before proceeding with full-scale data recording. If the overhead is found to exceed acceptable limits, adjustments can be made to what is instrumented and what is recorded, and the overhead measured again as required. Overhead measurement is discussed in greater detail below.

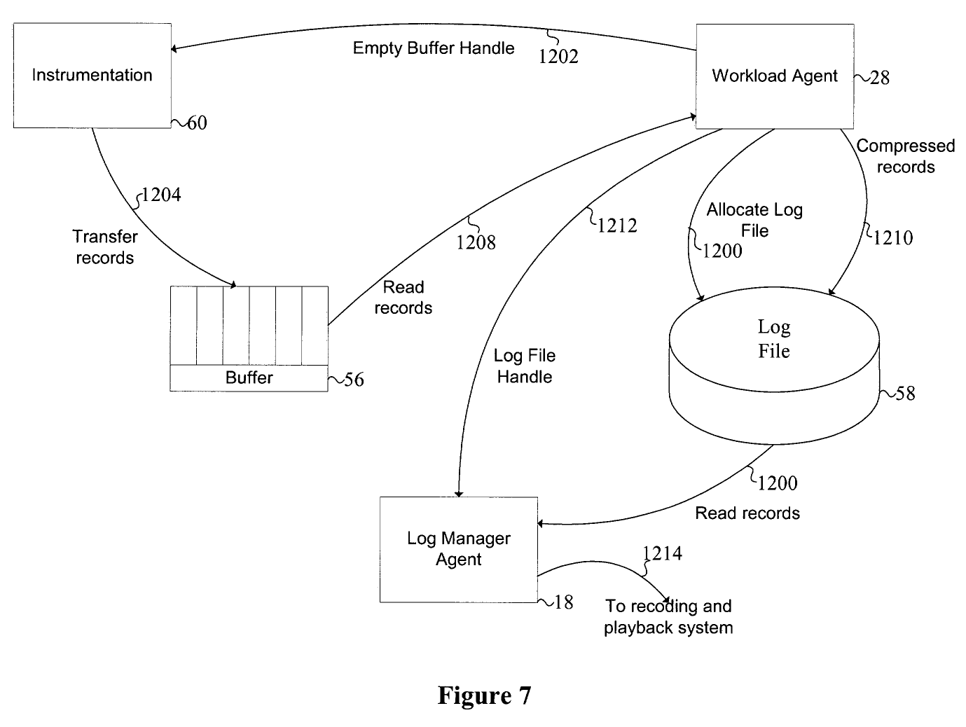

FIG. 7 is a data flow diagram showing simplified data recording entity relationships used in some embodiments. This figure is intended to show only an overview of the interaction between these entities, with the details of each interaction or process discussed elsewhere.

The workload agent 28 allocates a log file 1200, 58 for each log entry class into which the captured request and response arguments can be recorded. The workload agent manages the buffer 56 by transmitting a handle 1202 for an empty buffer for each log entry class to the instrumentation 60. When the instrumentation encounters an entry that is to be recorded, it transfers a record 1204 containing the entry or arguments for that entry to the allocated buffer.

Periodically, the workload agent 28 reads records 1208 from the buffer 56, compresses them or otherwise processes them, and transfers the compressed or processed records 1210 to the log entry files 58. At the conclusion of the recording process or at periodic intervals during the recording process, the workload agent 28 transmits the file handles 1212 for the log entry files 58 to the log manager agent 18. The log manager agent 18 uses the file handle for the log entry files to read the records 1200 from the log file 58. The log manager agent 18 then transfers the records 1214 to the recording and playback system 10.

Workload Recording with Byte Code Instrumentation

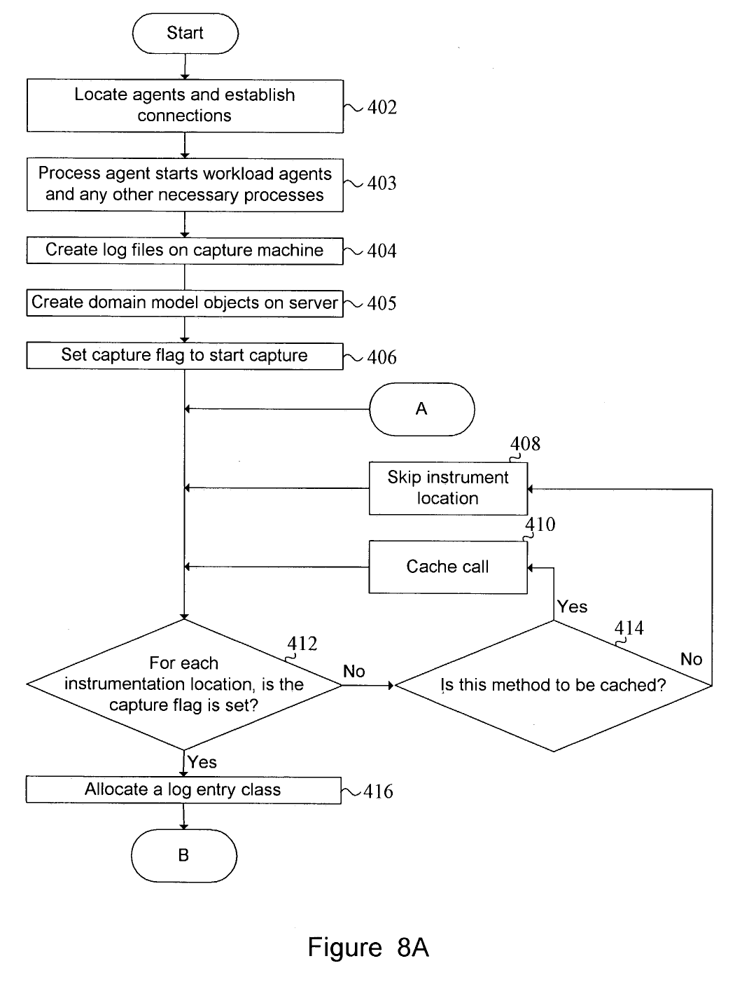

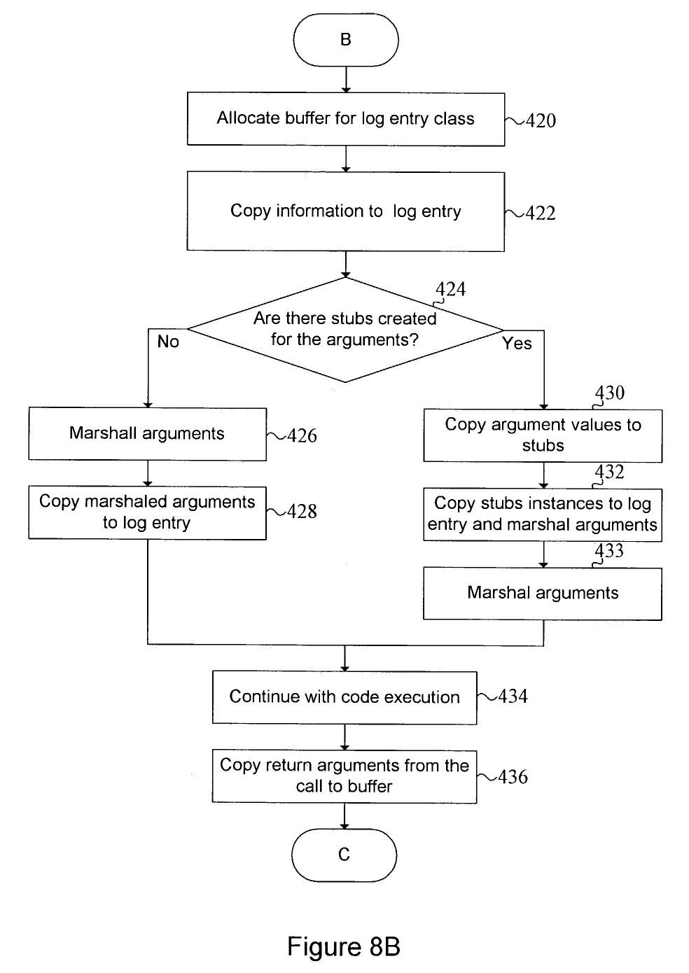

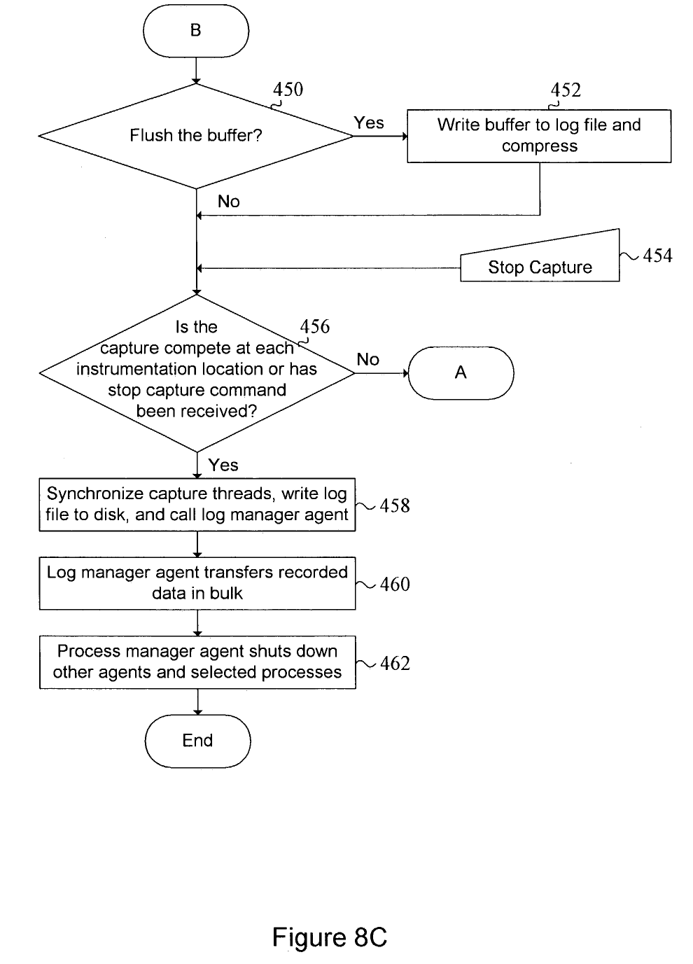

Once the byte code instrumentation has been installed as described above, the capture or recording of data can commence on the system under test 10. The capture and recording of live data can be done either to create a workload for playback or as part of a playback experiment. FIGS. 8A, 8B and 8C are flow diagrams showing a simplified view of a byte code workload capture process used in some embodiments.

In step 402, the master control and data management server 46 locates and starts the agents 12 on the system under test 10 and establishes connections with them. In step 403, the agents 12 use the process manager agent 22 to start the workload agents 28, the probes 24 and any other necessary processes. In step 404, the workload agents 28 create the log files 58. In step 405, the master control and data management server creates the domain model objects.

In step 406, the workload capture agent 54 commences recording by setting the capture flags to the positive position. In step 412, for each instrumentation location 60, the instrumentation checks to see if the capture flag is set. If the flag is not set, the instrumentation determines in step 414 if the method being called is to be cached. If so, in step 410 the call is stored in the cache buffer. If not, the execution of the instrumentation at that location is skipped in step 408.

If the flag is set for an instrumentation location 60, in step 416, the workload agent 28 allocates a log entry class in the log file. After step 416, the flow of execution continues through connector B in step 420. In step 420, the record agent 28 allocates a buffer for the log entry class allocated in step 416. In step 422, the instrumentation copies information on the class to the log entry file. This information typically includes:

1. class name;

2. object ID;

3. method name;

4. arguments;

5. start time; and

6. required resources.

In step 424, if stubs have been created for the arguments to the method, then in step 430 the instrumentation 60 creates an instance of the stub object and copies the argument values to the stub (i.e., the values of the arguments in the method call). In step 432, the instrumentation copies the stub instances to the log entry buffer In step 433, the instrumentation marshals the arguments for the method.

If stubs have not been created for the arguments to the method, then in step 426 the workload agent 28 marshals the arguments to the method. In step 428, the instrumentation 60 copies the marshaled arguments to the log entry buffer.

Once arguments have been marshaled and required log entries have been written to the buffer, in step 434, normal code execution continues. In step 436, the instrumentation 60 captures the return arguments and writes these arguments to the buffer for the log entry class. After step 436, the flow of execution continues through connector C in step 450.

In step 450, the workload agent 28 determines whether to flush the buffer, based on buffer capacity and performance considerations. If the buffer is to be flushed, in step 452, the workload agent writes the buffer to the log file and performs any desired compression. Suitable compression methods are discussed below.

In step 456, if the capture is complete for all instrumentation 60 locations or a stop capture command has been received in step 454, the capture is terminated. If the capture is terminated, in step 458, the workload agents 28 synchronize capture threads, copy all buffer entries to the log file 58 and call the log manager agent 18. In step 460, the called log manager agent transfers the files to the recording and playback system 50, where the master control and data management server 46 places the files in the data storage 48. In step 462, the process manager agent 22 shuts down other agents and selected processes. If the capture is not complete, then the flow of execution continues through connector A in step 412 to again determine if the capture flag is set.

Fixed Interface Workload Recording

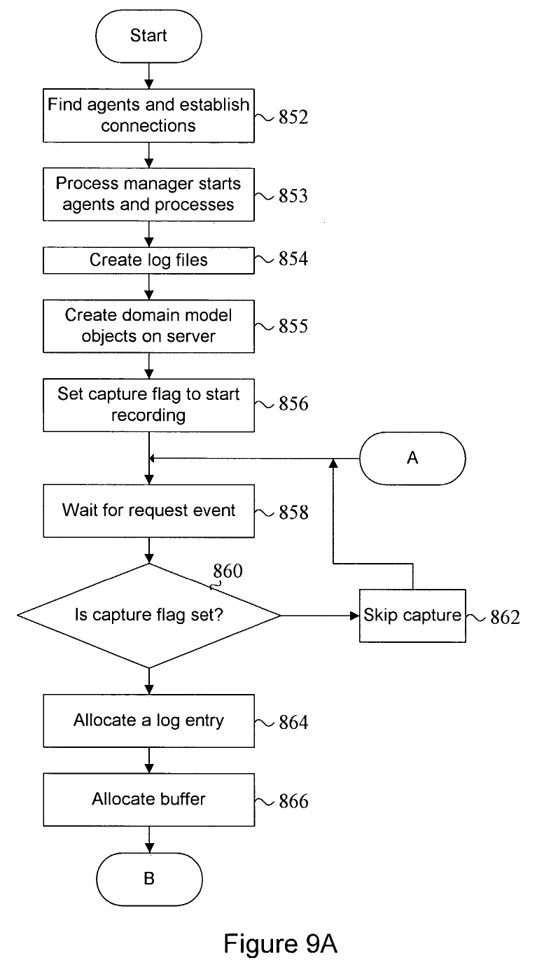

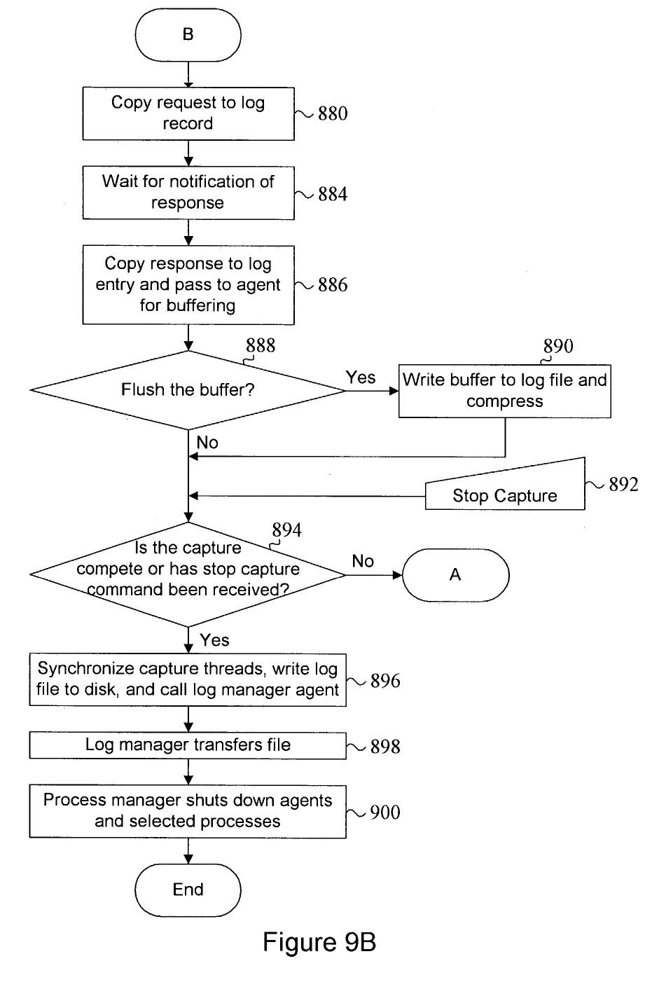

The system can capture live request and response data from stateless servers using the instrumentation 60 installed on the system under test 10. FIGS. 9A and 9B are flow diagrams showing a simplified view of a workload recording process used in some embodiments.

In step 852, the master control and data management server 46 locates the agents 12 and establishes connections to them. In step 853, the process manger agent 22 starts other agents and selected processes. In step 854, the workload agents 28 create the log files 58. In step 855, the master control and data management server 46 creates the domain model objects. In step 856; the instrumentation agent 54 sets the capture flags to start the recording process.

In step 858, the instrumentation 60 waits for a request event. When an event arrives, in step 860, the instrumentation determines whether the capture flag is set. If the capture flag is not set, the capture is skipped in step 862 and the instrumentation resumes waiting for a request event in step 858. If the capture flag is set, in step 864, the workload agent allocates an entry in the log 58. In step 866, the workload agent allocates a buffer 56 for the thread executing the instrumentation code to store log records. After step 866, the flow of execution continues through connector B in step 880.

In step 880, the instrumentation copies the captured request to the log record. In step 884, the instrumentation waits for a response notification from the server. When the response is received, in step 886, the instrumentation copies the response to the log entry and passes the log entry to the agent for buffering and storage.

In step 888, the workload agent 28 determines whether to flush the buffer, based on buffer capacity and performance considerations. If the buffer is to be flushed, in step 890, the workload agent writes the buffer to the log file and performs any desired compression. Suitable compression methods are discussed below.

In step 894, if the capture is complete for all instrumentation 60 locations or a stop capture command has been received in step 892, the capture is terminated. If the capture is terminated, in step 896, the workload agents 28 synchronize capture threads, write the buffers to the log file 58 and call the log manager agent 18. In step 898, the log manager agent 18 transfers the files to the recording and playback system 50, where the master control and data management server 46 places the files in the data storage 48. In step 900, process manager agent 22 shuts down other agents and selected processes. If the capture is not terminated, the flow of execution continues through connector A in step 858 to wait for the next request event.

State Capture

In many cases, for responses to a request during playback to accurately reflect those on the live system, the state of the system under test 10 must be substantially identical to that on the live system. System state for the system under test must be captured as part of the data recording process and restored at playback time. If the appropriate system state cannot be captured and restored, the system parameterizes the captured workload to correspond to the system state where the workload is being played back. System state can include both static and dynamic components. The recorded state information is used to restore the system state prior to playback. The restoration of system state is discussed together with other aspects of playback below.

The static state components for the system under test 10 are typically captured before or after the recording of an entire workload consisting of a stream of request and response data. Static state information is typically contained in the nonvolatile memory of the system under test. Examples of static state information can include:

1. information in the database 38, including log files;

2. other data in the file system of the system under test 10; and

3. executable programs and scripts on the system under test 10.

Static system state can be captured in a number of ways. In some cases, copies can be created for one or more parts of the file system of the system under test 10. Database 38 state, while static in structure, typically changes in content during the processing of requests and responses. Thus the database state is usually captured as a snapshot at some point in time before or after the recording of the workload consisting of the requests and responses. A marker is created at the time when the recording of requests and responses begins, and is inserted into the database log. The captured state consists of the database log, including the marker. During playback, the database state is rolled forward or backward to the time at which the marker was created (depending on whether the marker was inserted before or after the workload recording), typically using the information in the log files. The exact method used to capture database state and create a marker typically depends on facilities available in the database management system 36 and the hardware/software configuration used. Some examples include:

1. If a mirrored or other redundant storage system is used for the database 38, the mirror can be broken at the time data recording begins, with the break constituting the marker; or

2. A full or partial backup is made of the database 38 prior to starting the entire recording process. Then, just before the starting a recording, a marker can be inserted into the database log or the log sequence number for the first event be recorded. The full or partial backups along with the log files and the marker constitute the full database state that needs to be captured.

The dynamic state of the system under test 10 changes during its processing of requests and responses. The dynamic state includes the state of the front-end processor 26, the application 30, the application server 34 and other tiers of the N-tiered system (except for tiers that are stateless). Dynamic state can also include any state properties of the underlying operating systems used in the system under test. Examples of dynamic application state include:

1. the state of sessions and session identifiers including cookies;

2. the presence of transactions; and

3. the number of active requests or threads.

Examples of computer system or operating system state include:

1. the number of processes running;

2. the size of the virtual and physical memory used by the running processes;

3. the number of open file descriptors; and

4. the number of open connections.

In some embodiments, the dynamic state for the system under test 10 is sampled during the recording process by one or more probes 24. State information from the probes is transferred by the probe agents 16 to the data collector 52 and is ultimately saved in the data storage 48 by the master control and data management server 46.

Compression Methods

In some embodiments, compression methods are applied to the data recorded from the system under test 10. In some cases, the workload agents 28 perform compression on data stored in the buffers 56. The use of compression can reduce the overhead of instrumentation 60 by reducing the size of buffers or the volume of data to be stored in the log file 58 or transferred to the data storage 48. Compression can also improve the scalability of the instrumentation system by allowing more data to be recorded in the log files or data storage without requiring excessive file sizes. The compressed files are typically decompressed at post-processing or playback time. Both semantic and syntactic compression and decompression techniques can be used.

Those skilled in the art will be aware of a number of suitable syntactic compression techniques that can be applied to recorded data. Well-known examples of syntactic compression include those used in the GZIP algorithms.

Semantic compression can use semantic information about the workload being recorded to reduce the amount of stored workload information. Examples of semantic compression techniques can include:

1. Storing only the parameter or argument values for requests and responses for a particular interface or method name, without the need to record entire objects; and

2. Storing the cookie used in one session only once instead of storing it with every request in that session.

Instrumentation Overhead

The measurements made during data recording accurately reflect a deployed system only if the instrumentation and recording processes have low overhead. Put another way, the system resources consumed by the instrumentation and other processes involved in data recording must be low to ensure the accuracy of the system performance in the system under test 10 when compared to the same system without instrumentation. System performance metrics that may be affected by these sources of overhead include CPU utilization, response time and throughput. To achieve an acceptably low overhead the system applies a number of techniques including.

1. Using caching schemes, as is discussed above, reduces the overhead associated with recording the arguments of requests and responses.

2. Buffering recorded data in real time in high-speed memory reduces the storage overhead and allows deferring storage operations to lower speed nonvolatile memory until system resources are available.

3. Compressing the recorded data in real time reduces the amount of data that needs to be stored in nonvolatile memory which decreases the impact on I/O resources of the system under test.

4. Using an efficient mapping scheme for classes, methods and interfaces mapping scheme to determine which sets of request and response arguments are to be captured and recorded.

5. Using an efficient mapping scheme between names of classes, methods, names, and arguments causes small tokens to be recorded instead of long and complex names.

The usefulness of the recording system varies inversely with its level of overhead. The recording system's level of this overhead is measured in terms of its impact on the CPU utilization, throughput and response time by comparing these metrics for the same workload before and after the workload recording is initiated. The lower the overhead, the greater the usefulness and effectiveness of the workload recording system.

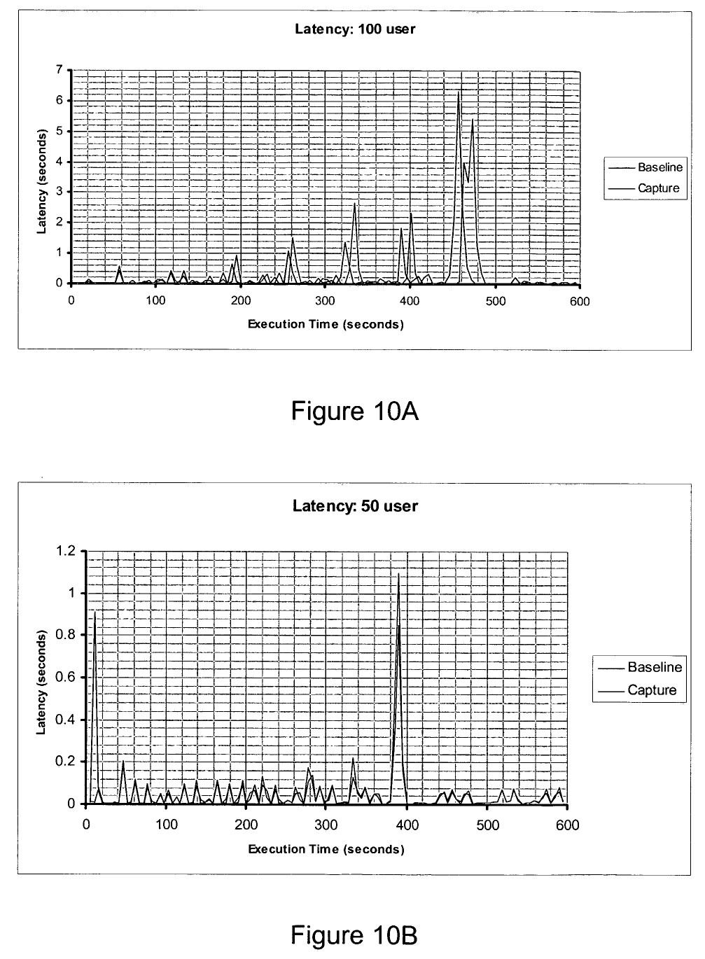

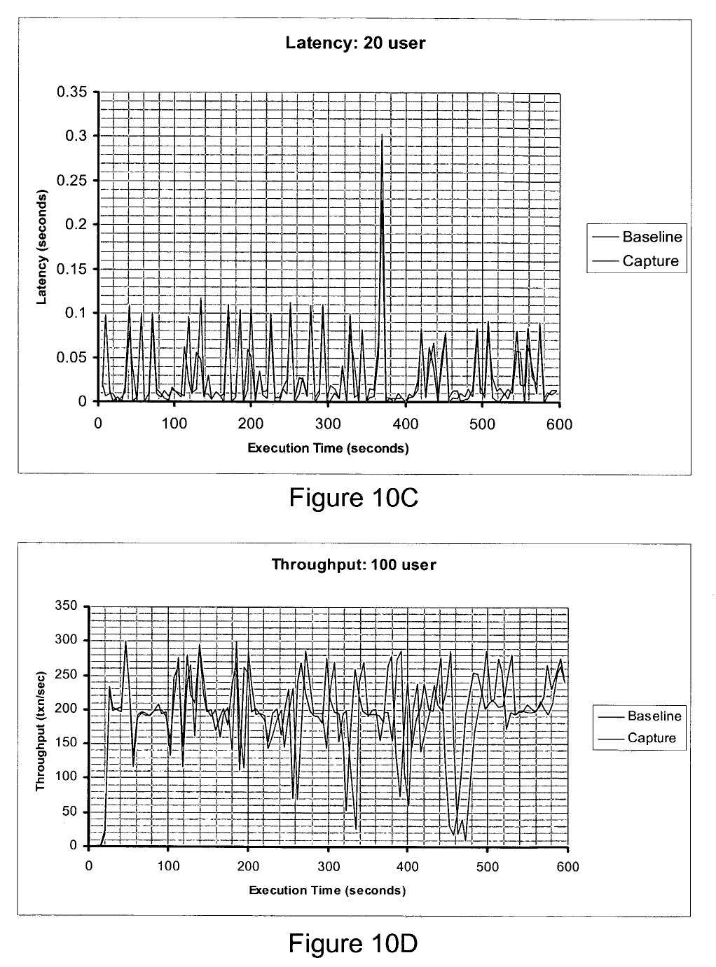

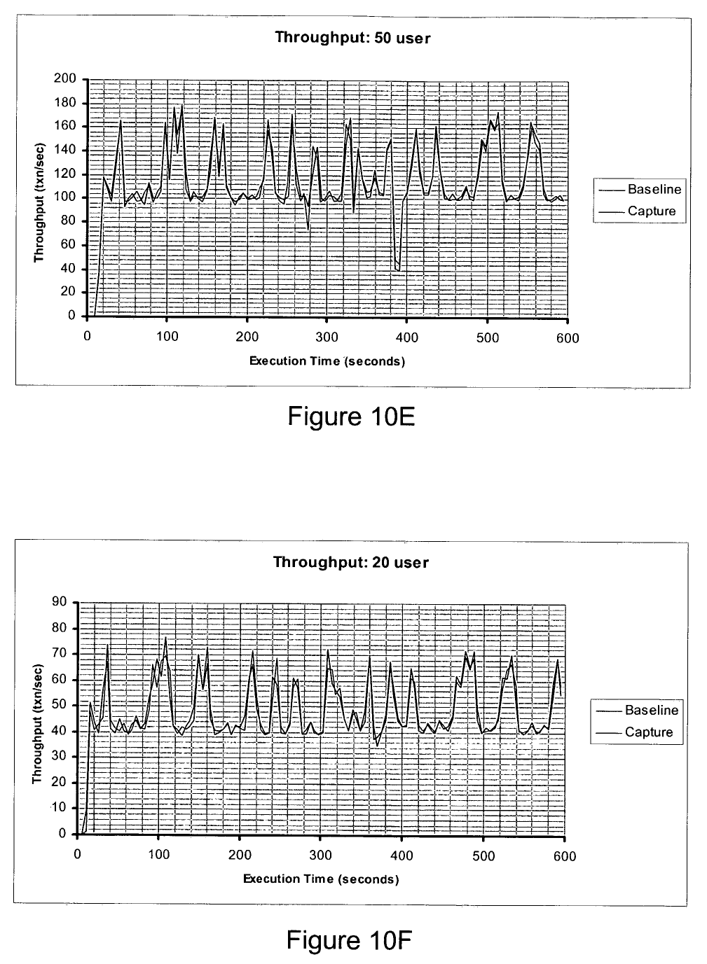

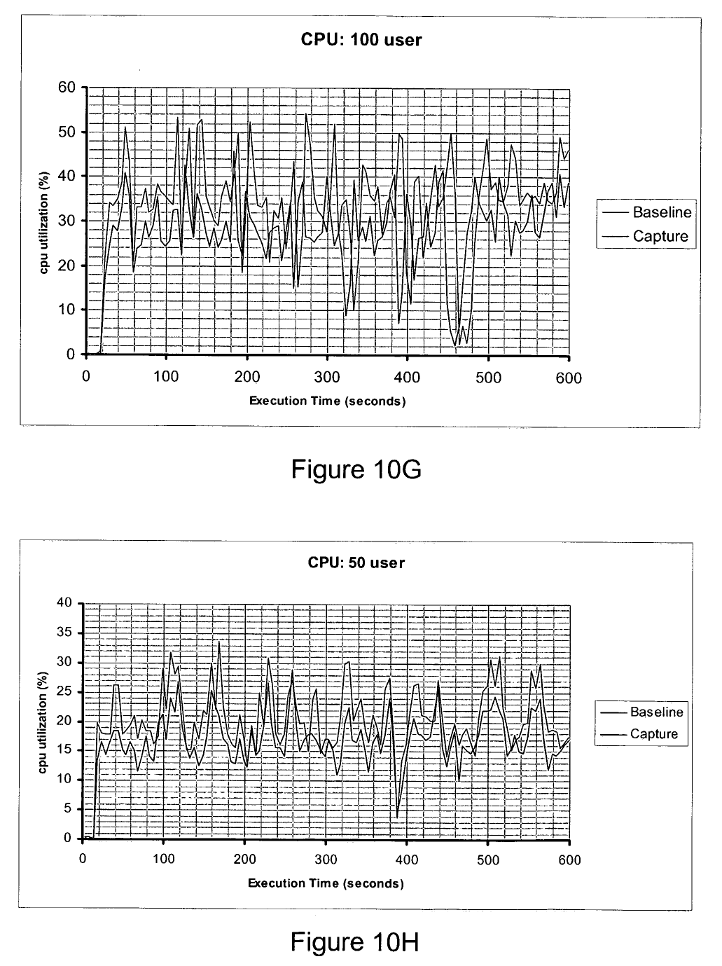

FIGS. 10A-10I are graphs showing experimentally-recorded overhead measurements. These graphs show system resource utilization metrics for a typical application and a workload of 20, 50, and 100 users captured over a period of 10 minutes. The metrics recorded are latency-also called response time, throughput and CPU utilization. In each graph, the utilization of some system resource is shown both for the case where instrumentation is inactive (“Baseline,” shown in blue), and for the case where instrumentation is active (“Capture,” shown in red). For latency or response time, the overheads between Baseline and Capture range from approximately 0% to 5% for 20 users (FIG. 10C), 50 users (FIG. 10B), and 100 users (FIG. 10A). For throughput, the overheads range from approximately 0% to 5% for 20 users (FIG. 10F), 50 users (FIG. 10E), and 100 users (FIG. 10D). For CPU utilization, the overheads range from approximately 0% to 15% for 20 users (FIG. 10I), 50 users (FIG. 10H), and 100 users (FIG. 10G). Overheads that are this low are considered to have minimal impact on normal operations of systems under high load conditions.

Recording of Workloads Larger Than the File System Size Limits

In some cases, the size of the workload to be recorded exceeds a size limit of the file system for the system under test 10. In these cases, the workload can be divided into two or more independent streams, with each of the streams stored in multiple smaller log files 58 in the system. The streams may be compressed.

Overview of Post-Processing

Once a workload has been recorded, a post-processing step may be applied prior to playback. Post-processing can involve a number of steps. In some embodiments, the master control and data management server 46 performs the post-processing on recorded data stored in the data storage 48. These same steps can also be performed during recording or playback. Typically, once post-processing has been completed, the workload is ready for playback. The choice of the order of workload processing can often be a matter of choice, or based on performance and scalability requirements.

The details of the algorithms applied during post-processing can depend on the nature and type of the interface at which the data are recorded and played back. Specific processing steps are typically used for either internal (e.g., byte code) interfaces or external interfaces (e.g., fixed API). Based on the interface and data characteristics, the correct processing steps and criteria can be selected. Post-processing techniques for both internal and external interfaces are discussed in greater detail below.

In some cases, recorded data records may be censored. Such censoring is typically performed either (1) when only part of a request or response has been recorded, or (2) when complete requests and responses are recorded in the middle of a user session, as part of an incomplete session. Such incomplete records or sessions are censored by removing them from the workload. Censoring techniques are discussed in greater detail below.

In some cases, a workload is recorded in multiple streams, as described above. These workload streams are typically combined and globally ordered during post-processing. This combining and ordering process helps ensure that the order of dependent requests will be correct during playback. Combining and ordering recorded workloads is discussed in greater detail below.

In some cases, a parameterization step is applied to the workload before playback. During the parameterization, process substitutions are made for key argument values. Such parameterization ensures that argument values agree with the system or database state at playback time. In addition, a variable substitution process can be applied to arguments that cannot be recorded-for example, because of security concerns-or that are dependent on other argument values that are generated during playback. Parameterization of arguments can be performed, either in a batch manner, or in real-time during playback. Variable substitutions are generally performed in real-time during playback, but are discussed in this section for completeness. Detailed descriptions of parameterization in general and parameter substitutions are given below.

Workloads can be synthesized from other workloads using combining and scaling techniques. Depending on the requirements for playback, a given workload can be scaled up or down. Repeating requests and then parameterizing them with different argument values can create a larger workload. Subsetting a larger workload can create a smaller workload. In some cases, large workloads or workloads requiring high throughput rates are partitioned before playback. During the partitioning process, a workload is divided into several (possibly independent) workloads, which can then be played-back as multiple independent streams. Workload scaling and partitioning are discussed in greater detail below.

Censoring of Incomplete Data

In a typical recording process, some sessions and connections may exist before the recording session starts, in which case a series of requests and responses for which the starting context is unknowable are recorded. At the same time, there may be requests made before the recording session has started, and for which orphaned responses are recorded. There can also be requests recorded toward the end of a recording session for which the responses are not recorded. In these and similar cases, the incomplete sessions and orphaned data should be censored before playback commences. In some embodiments, orphaned requests and responses are identified and censored during post-processing. In other embodiments, censoring can take place during recording, such as during a data aggregation step.

In some embodiments, the amount of data requiring censoring can be reduced by recording data for some period of time before and after the actual period of interest. In this way the probability of recording corresponding requests and responses for events in the period of interest is increased.

Combining and Ordering Recorded Streams

In some embodiments, streams of records or units of work may be recorded at multiple interfaces within the N-tiered system under test 10. In other embodiments, the system under test may have multiple instances of the same interface, which can produce multiple recorded streams. In yet other embodiments, live-recorded data is combined with synthetic data. In these and other cases, the multiple streams of units of work may need to be combined to create an integrated workload. Examples of systems under test with multiple instances of the same interface include systems distributed over a network or systems that use clustered servers.

In some embodiments, the sessions and requests are globally ordered as a prerequisite to combining the workload streams. The global ordering helps ensure the order of requests presented to the system under test 10 is correct. For example, the ordering ensures that requests that depend on or require the results of previous requests are ordered properly.

Parameterization

Parameterization of the workload is performed to insure that the values of arguments in the requests comprising the workload agree with the state of the application and the database 10 during playback. Parameterization can be performed in a batch at post-processing time. Typically, the master control and data management server 46 performs the batch post-processing on the records in the data storage 48. Alternatively, parameterization can be performed in real-time during playback. In some embodiments, tags are attached to parameters either during data recording or during post-processing to identify the parameters and values that may need to be replaced before or during playback. In addition, a mapping table that describes the rules for mapping from the tagged parameter values to the new parameter values that reflect the data values for the new application or database state is provided to complete the parameterization process. The source of this mapping table can be a program, a file, a database, or any other form of data stream. A mapping rule in a mapping table can be an arbitrary code fragment that can be registered as a handler to be used for parameterization during capture or playback. This handler may be invoked before or after each request is recorded or played back. When invoked, a handler could be applied to the current request, all of the preceding or future requests for a session or all of the preceding or future requests for a captured workload. This handler may be specified as a program in an arbitrary programming language such as Java or C++. At playback time, the playback agent 14 uses these tags to invoke a handler that assembles the arguments using the mapping table and sets the values. In some embodiments, parameterization can be applied to alter the database state or application state to match the modified workload. In other embodiments, the parameterization is applied both to the workload and the database state to insure that they agree. Typical variables that may require substitution include three general types:

1. System generated values, date and time;

2. System generated identifiers such as transaction identifiers, object identifiers, thread identifiers and database row identifiers; and

3. Application identifiers such as account number, customer identifier, employee number and student number.

Variable Substitutions

In some embodiments, variable substitution or variable hiding is performed to prevent the recording of sensitive information. Examples of data that should not be recorded because of security or regulatory considerations include:

1. Financial account numbers and data values;

2. Security information, including passwords, personal identification numbers and shared secret keys;

3. User names or other personal identifiers; and

4. Personal information including, names, addresses, social security numbers, income information and tax information.

In some embodiments, the data hiding process can be implemented as a special case of the parameterization process. In this case, the mapping table described earlier specifies a one-way transformation or value substitution that is applied to the variables whose values are not to be recorded. The one-way transformation or substitution prevents the recovery of the original data values from the transformed workload. At post-processing time or playback time, the variable substitutions are made either from the table or dynamically. In some embodiments variable substitutions are made both in the database 38 and in the workload to ensure the substituted values agree.

Workload Scaling and Partitioning

In some embodiments, one or more workloads with different combinations of records or units of work can be created for playback. The records or units of work can be from live recording of data, synthetic data or a combination of live and synthetic data. The workloads created can be played back to create a wide range of load throughputs and run durations for nearly any interface for the system under test 10.

Removing units of work from an existing workload can create workloads of shorter durations. In one example, a particular segment of a longer workload is retained and the rest discarded. In another example, the units of work are chosen by pseudorandom or other suitable sampling schemes. In some cases, the units of work retained will be complete sessions, so that state can be retained and sequences of potentially dependent requests are maintained in order. Parameterization of the new workload and possibly the database 38 may be done to ensure correspondence between the workload and the required system state.

A longer workload can be created by repeating records from an existing workload or combining units of work from multiple workloads. In one example, units of work are concatenated to create a longer workload. In other cases, pseudorandom sampling or another suitable sampling technique is used to choose the sequence of the units of work. In some cases, the units of work selected will be complete sessions, so that sequences of potentially dependent requests and responses are maintained in order. Longer workloads are typically parameterized in a manner that prevents the repeating of the exact same units of work, which may create problems during playback in certain situations. For example, the customer identifier and items requested by be changed in records comprising an ordering session. Further parameterization of the new workload and possibly the database 38 may be done to ensure correspondence between the workload and the required system state.

In some embodiments, time dilation can be performed across the units of work or records in a given workload to modify the throughput level produced by playback of that workload. For example, the start time for the requests in the workload can be delayed to create a workload with lower arrival rate and hence a lower throughput. In other cases, the time between requests can be decreased to create workloads with higher throughput. In some cases, the order of requests within a session is maintained to ensure that sequences of potentially dependent requests are preserved in order to facilitate correct and accurate playback for a given database state.

In some embodiments, higher-throughput workloads can be created at playback time by playing back multiple workloads simultaneously. The units of work in these workloads can be derived from recorded data, synthetic data or a combination of both. These techniques can improve the scalability of the playback system. A large workload can be partitioned to create the multiple workloads. In some cases, the units of work selected for each workload will be complete sessions, so that sequences of potentially dependent requests are preserved in order to facilitate correct and accurate playback for a given database state. In other cases, several independent workloads may be used. In either case, load-balancing techniques may be applied to balance the throughput of the multiple workloads. In one example, multiple computers are used to play back the multiple workloads for an interface in the system under test 10.

Post-Processing for Workload Captured at Byte Code Level

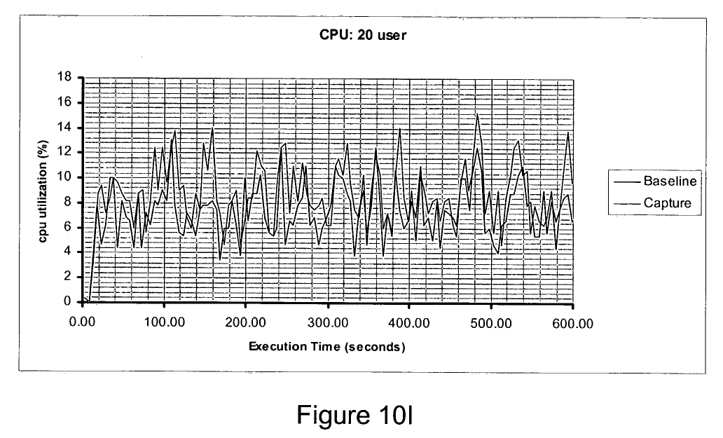

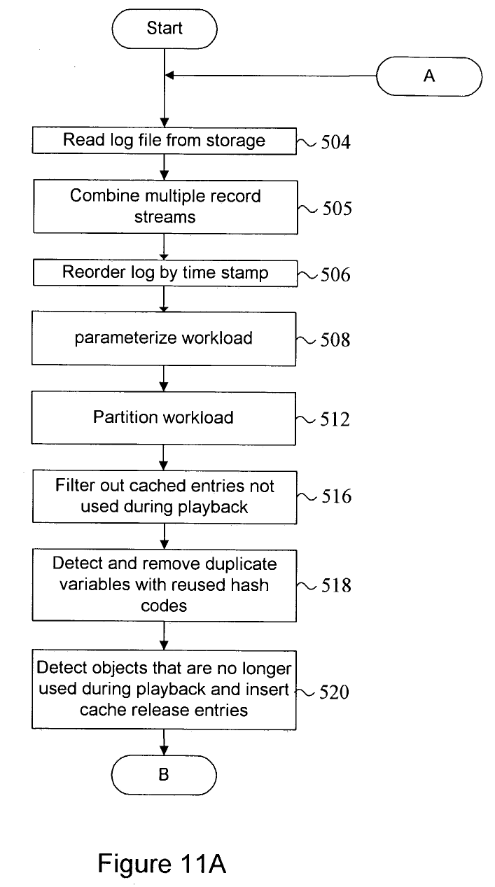

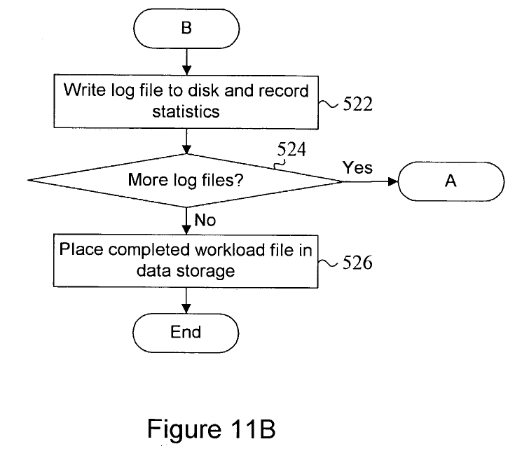

Once live data has been recorded from the system under test 10 as described above, the master control and data management server 46 may optionally apply post-processing steps to the data to prepare it for playback. FIGS. 11A and 11B are flow diagrams showing a simplified view of a byte code workload post-processing process used in some embodiments.

In step 504, the server 46 reads a log file from the data storage 48. In step 305, the server combines the record streams in the read log file. In step 506, the server reorders the records in the file by timestamp. This process globally orders the requests. In step 508, the workload is then parameterized, based on a parameterization specification. Methods for parameterizing workloads are discussed above. In step 512, the workload is partitioned based on a partitioning specification. In step 516, the server filters out cached entries that are not used for playback (e.g., by identifying cached methods that are used to provide the setup state for the playback). In step 518, the server examines reused hash codes for object references to remove duplicates. In step 520, any objects that are not used beyond a certain part of the playback are detected, and cache release entries are inserted into the log to make sure that the playback system releases these objects when they are no longer required. This ensures the scalability of the playback system by ensuring that it does not run out of memory. After step 520, the flow of execution continues through connector B in step 522.

In step 522, the post-processed log is written to disk, and the server records statistics on the post-processing. In step 524, if more log files are present, the flow of execution continues through connector A in step 504 to read the next log file from storage. If not, in step 526, the completed workload file is placed in the data storage 48. After step 526, these steps conclude.

Post-Processing for Workload Captured at a Fixed Interface

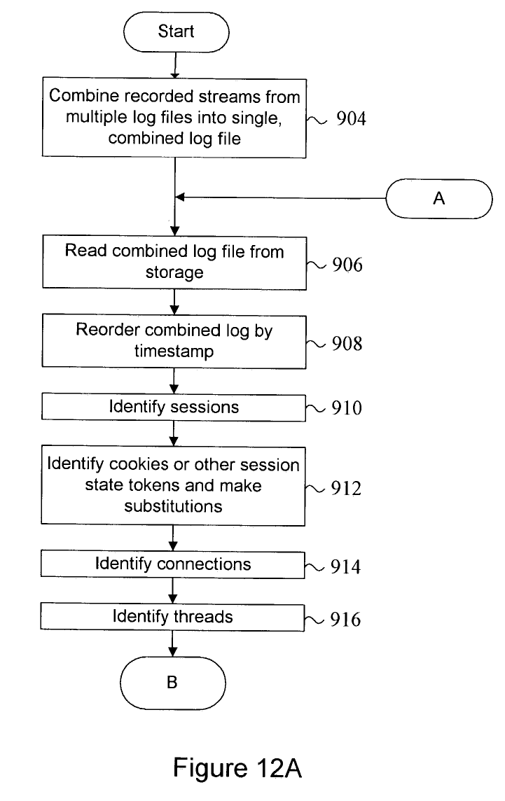

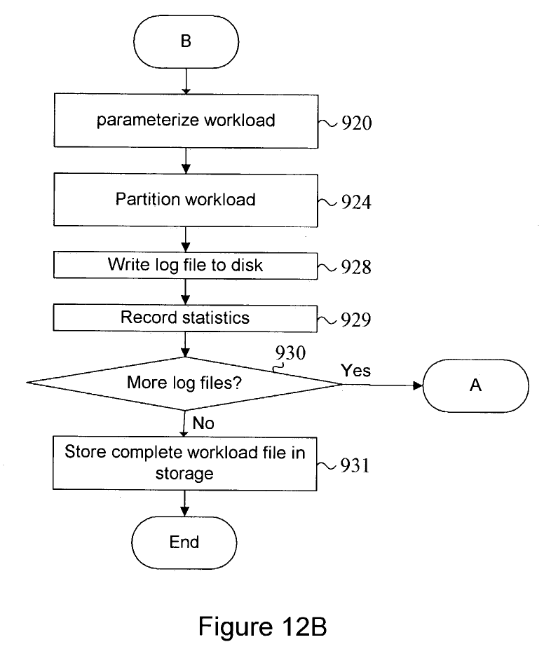

Once live data has been collected from instrumentation 60 connected to a fixed interface on the system under test 10, the workload can optionally be post-processed by the master control and data management server 46 to prepare it for playback. FIGS. 12A and 12B are flow diagrams showing a simplified view of a fixed interface workload post-processing process used in some embodiments.

In step 904, the master control and data management server 46 combines recorded data streams from multiple log files into a single, combined log file. In step 906, the master control and data management server 46 reads the combined log file from storage 48. In step 908, the events in the combined log are then reordered in accordance with their timestamps. This process globally orders the request records. In step 910, sessions within the log are identified. In step 912, cookies and other session tokens are identified and parameter substitutions are made. In step 914, connection within the sessions are identified. In step 916, threads within the sessions are identified. Thus, requests and responses can be correlated as belonging to a session and requests that must wait until a prior request has completed can be identified and treated as such. For example, some requests may use values returned from previous requests, or may rely on state change made by an earlier request (e.g., in the database 38) for correct processing. After step 916, the flow of execution continues through connector B in step 920.

In step 920, the combined workload is parameterized by the master control and data management server 46, using a parameterization specification supplied by the user. Methods for parameterizing workload are discussed above. In step 924, the workload is partitioned, based on a partitioning specification supplied by the user 926. In step 928, the server writes the post-processed log file to data storage 48. In step 929, the server records any statistics gathered from this process.

In step 930, if there are more log files, the flow of execution continues through connector A in step 904 to read additional log files from storage. If there are not more log files, in step 931, the server stores the completed workload file in the data storage 48. After step 931, these steps conclude.

Overview of Playback

During playback, a workload stream is used to stimulate a particular interface of the N-tiered system under test 10. The workload stream can be applied to any internal or external interface of the system under test. In some cases, the data recording and playback system records the responses generated by the system under test during playback. In general, the workload is applied to either an internal interface or an externally exposed interface such as an API. Performance measurements can be made on the system under test during playback.

In some embodiments, the workload is time-ordered, parameterized and stored in one or more log files 58. The time-ordering can be global across the entire workload, within a session or within a given unit of work. The choice of ordering strategy can be determined by the nature of the requests and the interface being stimulated on the N-tiered system under test 10. It will be understood that, in some cases, the responses will be received in a different order than the order of submission for the requests, due to asynchronous processing of workload requests in the system under test 10. Time-ordering ordering and other processing of the workload is discussed in greater detail above in conjunction with post-processing.

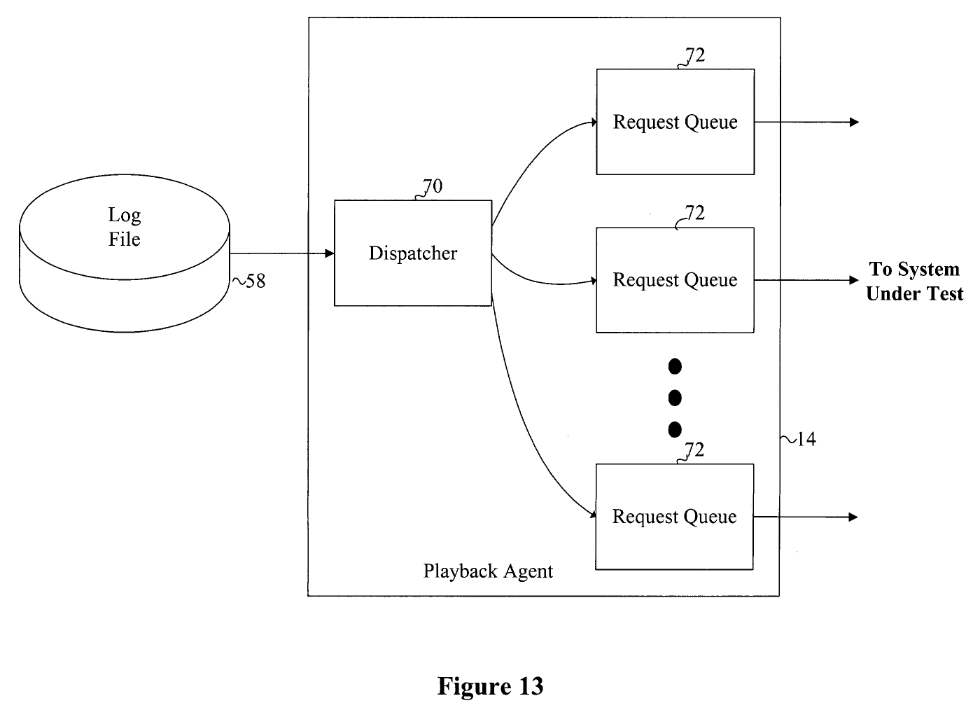

Once the workload is prepared for playback, the workload can be transferred to the system under test 10 and may be stored in the log file 58 on those machines. In some embodiments, one or more playback agents 14 control the playback process on the N-tiered system under test 10. FIG. 13 is a simplified block diagram showing components of a playback agent used in some embodiments. In some embodiments, a dispatcher 70 in the playback agent reads request records from the log file 58 and places them in one or more request queues 72. During this process, the dispatcher unmarshals the arguments and assembles the request as necessary. Such asynchronous prefetching and assembly of the request to the queues from the log file can significantly improve performance and reduce overhead of the playback mechanism on the system under test 10. When a thread has finished playing back its previous request, it dequeues the next request from the queue from which it is operating. Depending on the timing of that request, it waits for an appropriate time and then sends the request on to the system under test 10. The queues may serve requests to one or more threads in the playback agent. The dispatcher will create threads as required to play back the workload. The newly created threads are cached and managed by the playback agent

Parameter substitution can be applied to requests placed in the queues 70 by the dispatcher 70. In some embodiments, parameter values or handlers to compute parameter values are cached when they are used the first time. Request records in the log file 58 can use parameter tags to indicate the need for parameter substitution. The tags can be created at recording time or during post-processing. The techniques used for parameterization can be similar to the memorization approach used by some compilers. The value computed by the handler can then be retrieved rapidly from the cache when the parameter value is required for subsequent requests. Periodically, less frequently-used values or handlers can be flushed from the cache in order to manage its size. Parameterization is discussed in additional detail above.

The performance, performance accuracy, and semantic correctness of the system under test 10 can all be evaluated as part of the playback process. These measurements can be made and displayed in real-time during the playback process. Operators can use this real-time display to determine if the accuracy and correctness of the playback is within acceptable limits. In some other cases, the performance and accuracy measurements are made in real-time during playback, but are analyzed or displayed at a later time. In yet other cases, some combination of real-time and post-playback display and analysis is performed. Performance measurements, performance accuracy and correctness measurements are discussed in greater detail below.

In some embodiments, both static and dynamic system state is restored as part of the playback process. In most circumstances, restoration of system state in the system under test 10 is required to ensure the semantic correctness and performance accuracy of the playback. Static system state includes data and programs in the file system of the system under test, including the database 38. Dynamic state is typically restored during the playback process, and can include creating or maintaining the sessions, connections, and other dynamically created state conditions or data that was recorded during workload capture. The capture and restoration of system, application, and database state is discussed in greater detail below.

Errors can be encountered as the system under test 10 processes the workload. Error conditions may be returned as part of the response to a request. The playback and response recording system can identify the error, parse information from the error, and process the error. Error processing during playback is discussed in greater detail below.

In some cases, the requests can be served from the queue 72 to a particular thread, generally identified by thread ID. This approach can be used in cases where a goal is to match the performance characteristics of the system under test 10 during playback as closely to the conditions during data recording as possible, e.g., by creating a one to one correspondence between threads and request at recording time and playback time. In some other cases, the request is served by any thread of an appropriate type (i.e., a thread associated with an interface of the appropriate type). In this case, the number of threads used for the playback can differ from the number present during data recording. Varying the number of threads allows collection of performance data with a differing number of threads, which can be useful when performing performance tuning, for example.

The dispatcher 70 can control several properties of the playback through management of the queues 72. The queue management scheme adopted is typically matched to the desired properties of the interface or tier of the N-tiered system under test 10 being stimulated. Some examples of suitable control schemes can include:

1. The dispatcher 70 places a single request at a time into each of the one or more queues 72. This approach may be suitable in cases where it is important to maintain a global ordering of requests for a given thread so that the requests are processed correctly by the system under test 10.

2. The dispatcher 70 places a predetermined number of requests in the queue 72 at a given time. This approach may be suitable in cases where it is appropriate to process the predetermined set of requests in parallel before synchronizing with the global dispatcher to obtain the next set of requests to process.

3. The dispatcher 70 places as many requests in the queue 72 as can be held in the queue or are in the log file 58. This approach may be suitable in cases where a high rate of requests is to be dispatched to the system under test 10, and where the requests are independent of each other and no ordering of these requests is required in order to maintain the semantic correctness of the playback.

In some embodiments, the dispatcher 70 has the capability to regulate the throughput of the workload during playback to control the performance properties of the system under test 10. In general, a control variable that specifies the rate at which requests are submitted is varied to achieve a desired performance metric (e.g., latency). Playback control techniques are described in additional detail below.

State Restoration

In many cases during playback, in order for the response to a request to accurately reflect the response to the same request on a live system, the application and database state of the system under test 10 must be substantially identical to that on the live system. In such cases, both dynamic and static system state must be captured during the workload recording process and restored and maintained during the playback process. The capture and recording of system state is described in additional detail above in conjunction with the data recording process.

Depending on the details of the embodiment and the methods used for recording, static system state can be restored in a number of ways. In some cases, copies of one or more parts of the file system of the system under test 10 can be restored before playback commences. As described above, database state can be captured and restored in a number of ways including:

1. If a mirrored or other redundant file system is used for the database 38, a redundant copy of the database is captured during recording time by breaking the mirror and this redundant database is made available for use during the playback; or

2. If a full or partial backup is made of the database 38 before or after the data recording and log files are captured during the recording, the database is restored and rolled forward or backward to the marker that was used at the start of the workload capture.

The data recording and playback system maintains the dynamic state of the system under test 10 during playback. In some embodiments, the dynamic state of the system and application resources for the system under test is periodically sampled during the playback process by one or more probes 24. If the state of the system under test does not match the state measured during playback, the playback agent 14 or process manager agent 22 changes the state by increasing or decreasing the usage of system and application resources. For example, if at a sample time during playback the number of active connections is not the same as that sampled at recording time, the playback agent changes the number of connections to match that sampled at recording time.

Control of Playback

In some embodiments, the playback process is automatically controlled. In the control process, the playback agent 14 adjusts the rate at which requests are queued to control the overall throughput rate of the workload. Adjustments are made in the controlling variable to achieve the desired result. Adjustments can be made at every sample period or based on a prediction made using the data from several sampling periods. Depending on the embodiment and objectives of the playback experiment, a number of possible control strategies can be applied, including:

1. Adjust the rate at which requests are queued during playback to match the rate measured during recording on the live system under test 10;

2. Adjust the rate at which requests are queued during playback to match a predetermined rate;

3. Adjust the rate at which requests are queued or the workload throughput to achieve a desired level of latency between requests and responses; and

4. During playback adjust the rate at which requests are queued or the workload throughput to achieve the latency between requests and responses measured during data recording on the live system under test 10.

Playback of Workload

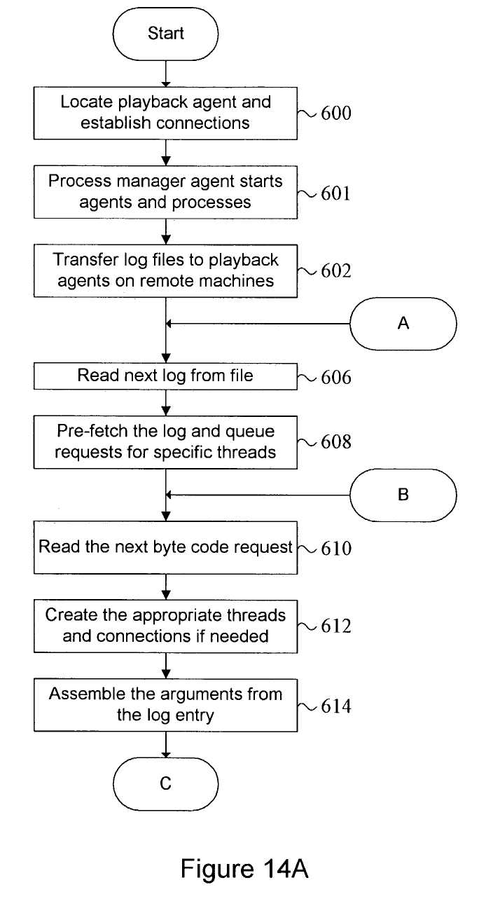

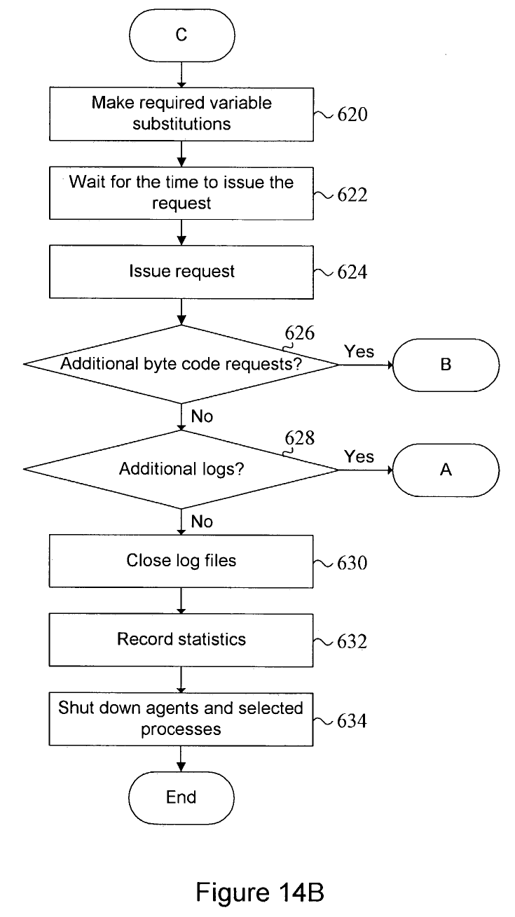

Once a workload is ready for playback, such as after post-processing as described above, the playback can commence on a system under test 10. FIGS. 14A and 14B are flow diagrams showing a simplified view of a workload playback process used in some embodiments. In some embodiments the process flow is the same for requests captured and recorded with both fixed and dynamic instrumentation 60.

In step 600, the master control and data management server 46 locates the playback agents 14 and establishes connections with them. In step 601, the process management agent 22 starts the other agents and any other necessary processes. In step 602, the log files containing the workload are transferred from the data storage 48 to the one or more payback agents 14. At this point, playback is ready to commence.

In step 606, the playback agent 14 reads a workload from a log file. In step 608, the dispatcher 70 pre-fetches the request from log 58, assembles the request with its arguments, places the request in the appropriate queue 72 and creates and caches the threads for the specific requests. By prefetching and assembling the log entries before they are required, the system minimizes the overhead associated with Disk I/O or network I/O, reducing the overhead impact on the accuracy of the playback on the system under test 10. In step 610, the dispatcher reads the next request from the log. In step 612, the dispatcher creates the required threads and connections for the request. In step 614, the arguments for the request are assembled or marshaled from the log entry file. After step 614, the flow of execution continues through connector C in step 620. At this point, the request is fully formed and ready to be served from the queue.

In step 620, the dispatcher makes any necessary variable substitutions in the arguments. In step 622, the dispatcher 70 waits for the required amount of time—determined by applying a function to the time difference between the previous and the current request—to dispatch the request from the queue 72. In step 624, the dispatcher issues the request from the queue 72. In step 626, if there are additional byte code requests in the log 58, the flow of execution continues through connector B in step 610 to read the next request. If not, in step 628, the playback agent determines if there are additional logs. If so, the flow of execution continues through connector A in step 606 to read the next log. If not, In step 630, the agent closes the log files. In step 632, the agent records the statistics gathered from the playback agent for the playback experiment. In step 634, the process manager agent 22 shuts down the required agents and processes. After step 634, these steps conclude.

Semantic Correctness Measurement

The semantic correctness of playback is a measure of how accurately the semantics of a response received from the system under test 10 during playback for a given request agrees with the response to the same request on the live system. The master control and data management server 46 typically compares the responses recorded during the playback with those recorded from a live system stored in the data storage 48. In some embodiments, the semantic correctness measurements can be displayed in real-time on the UI 44. An operator can use this real-time information to determine if a playback is created the expected results.

Semantic correctness can be measured by using any one or any combination of a number of measurements. In some cases, the expected values for the recorded quantities will not be identical to those recorded in the live system. These differences will often result from parameterization of the workload or changes in system state between live recording and playback, such as a change in data or time, transaction number or order number. Some examples of measured quantities that can be used for determining semantic correctness include:

1. the number of responses recorded for a given unit of work;

2. timing characteristics of recorded responses for a given unit of work;

3. argument values in the recorded responses for a given unit of work; and

4. performance accuracy

Performance Measurement Metrics

A variety of system measurements are used to collect performance metrics for the system under test 10. These metrics are used to assess the performance of the system under test in response to a given workload, the performance accuracy of the playback on the system under test and the overhead introduced by the instrumentation 60 into the system under test. In some embodiments, real-time metrics measurements are used to control the rate of the playback process as discussed above. The metrics can be measured at each of the tiers of the N-tiered system under test. Some examples of these metrics include CPU utilization, physical and virtual memory usage, throughput of workload requests through the system and the response time for workload requests on the system.

In some embodiments, the metrics data is collected in real-time by one or more probes 24 installed on the tiers of the N-tiered system under test 10. The probe agent 16 or another suitable client manages the probes and transfers the data to a data collector process 52 on the recording and playback system 50. The data collector aggregates the recorded data from the agents and forwards it to the master control and data management server 46. The server logs the data in the data storage 48, for later use, and displays various summaries and charts of the metrics on the user interface 44. The user or operator can use this real-time metrics display to judge the course of the data recording or playback experiment and determine if corrective action or termination of the run are required.

In some embodiments, the data recording and playback system can record performance measurements for the system under test 10, either on a live system or during playback. Performance measurements during playback can be made at various workload levels. For example, a system under test can be characterized with different levels of expected users (e.g., 10 users, 100 users or 1000 users). Alternatively, the performance changes associated with changes in design or configuration in the system under test can be measured (e.g., for performance tuning). For example, the number of threads and active connections between the tiers of the N-tired system under test can be altered and the performance compared. In yet other cases, the performance characterization can be performed with across one or more changes in the system under test and at a variety of workloads.

Performance Accuracy Measurements

In some embodiments, recorded metrics information is used to determine the performance accuracy of the system under test 10 during playback. In order for a playback to be useful, it must accurately reproduce the performance characteristics of the original system under test that was captured during the recording of the original workload. Comparing differences in value between one or more of the possible performance metrics during recording and playback for the system under test at the same throughput rate and workload allows this determination of performance accuracy. Some of the typical metrics used to measure the performance accuracy include: transaction throughput, transaction response time, CPU utilization and utilization of other system and application resources. In some embodiments, these captured metrics can be displayed in numerical or graphical form on the user interface. A user or operator can use this display to adjust the playback parameters or terminate a playback of a workload if the performance accuracy is less than an acceptable level. Since the accuracy of playback may depend on the total load on the system, it is important to measure the accuracy of the playback for different original captured workload with different duration, size, and rate of the workload which affects the load on the system.

One important characteristic of an effective or useful playback system is accurately reproducing the performance characteristics of the original system during playback using an unmodified workload. The greater the performance accuracy, the better the system under test 10 will represent a live system. The system described achieves high performance accuracy over a range of system loads and periods of time by showing a comparison of a particular performance statistic during workload recording, and the same performance statistic during workload playback.

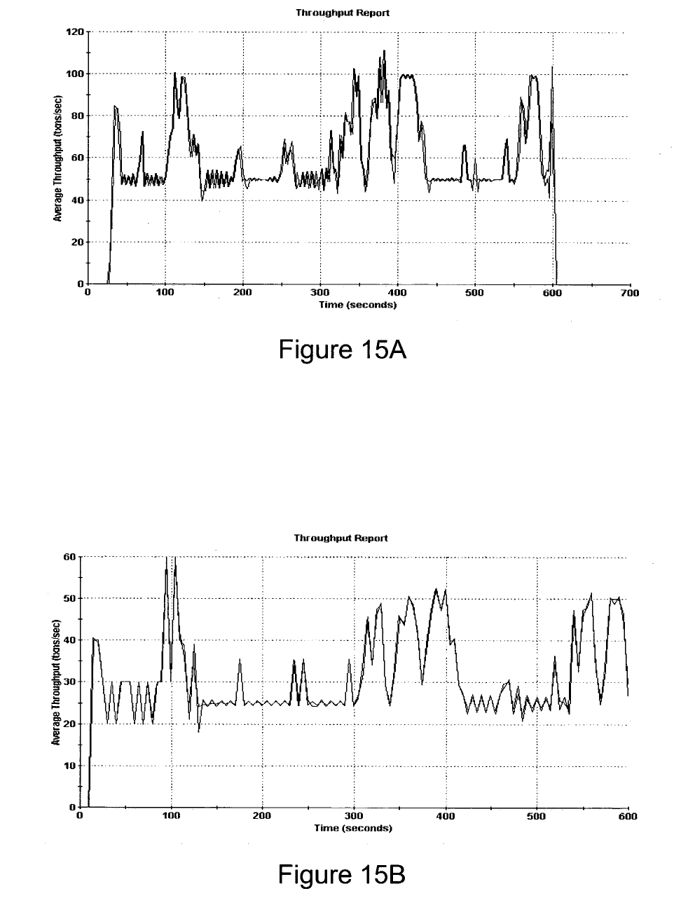

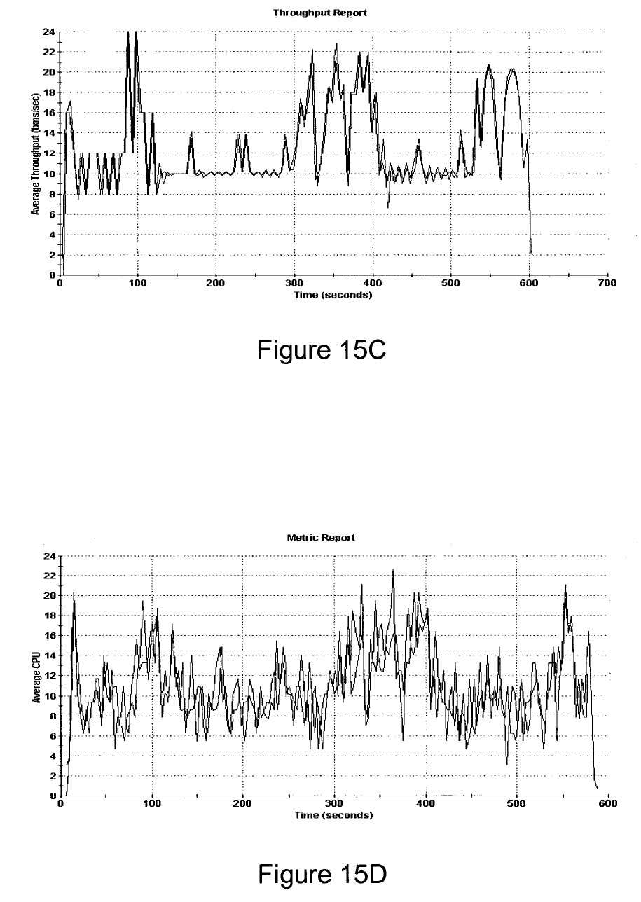

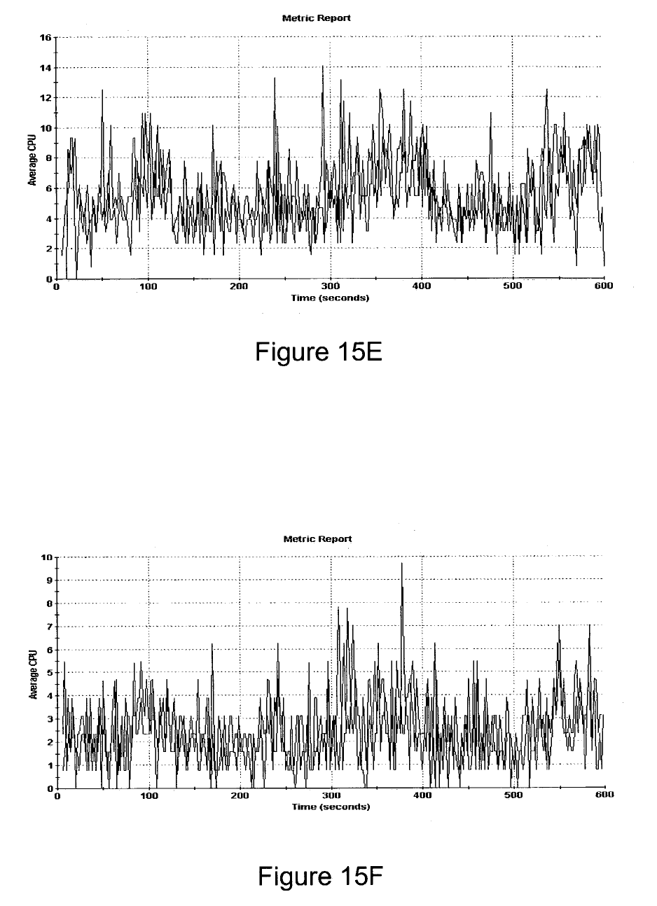

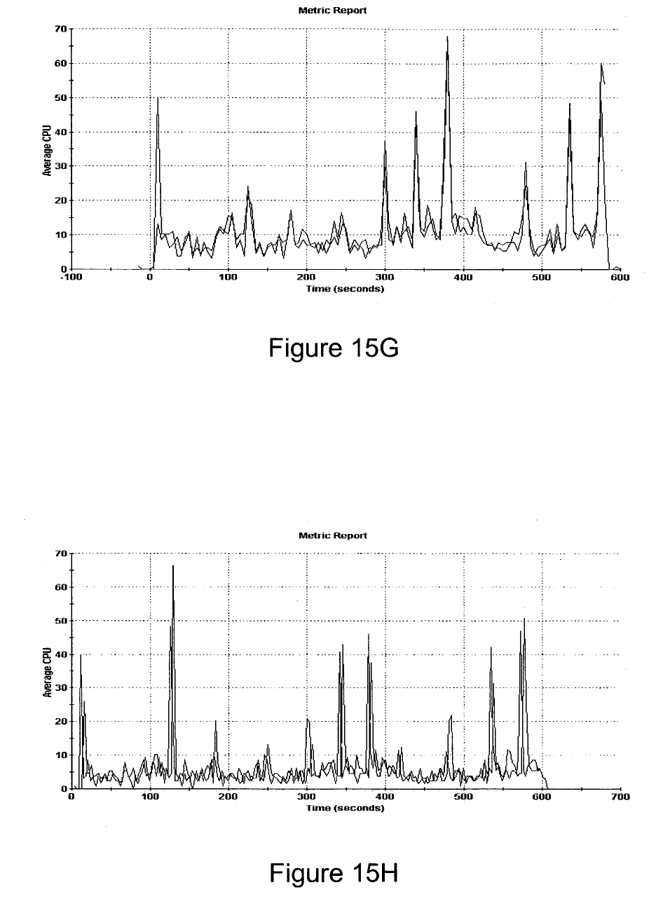

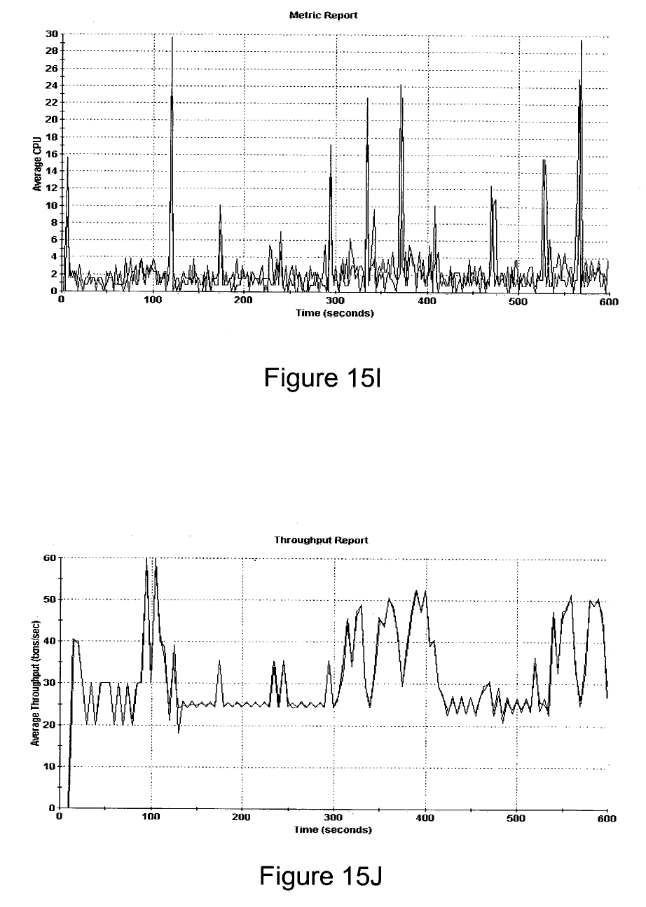

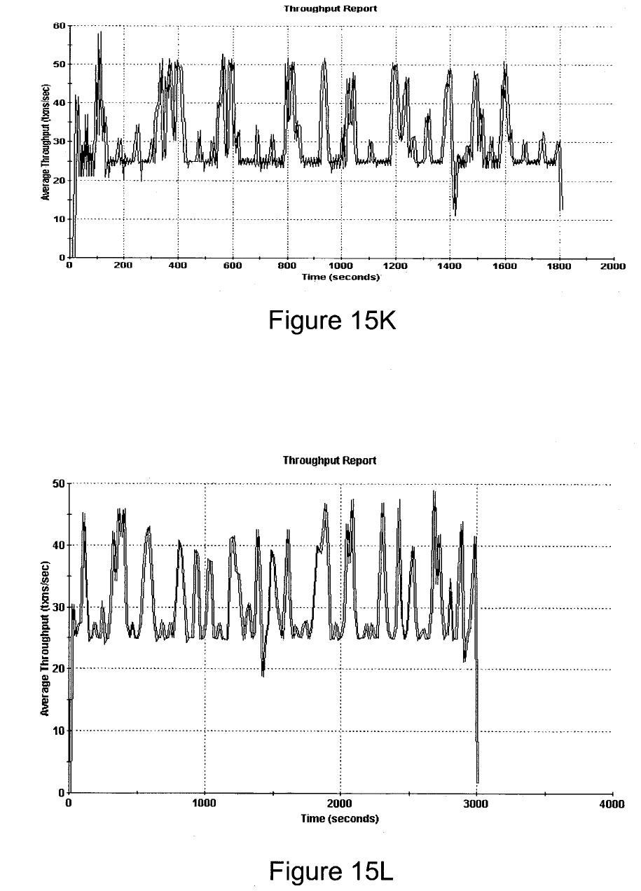

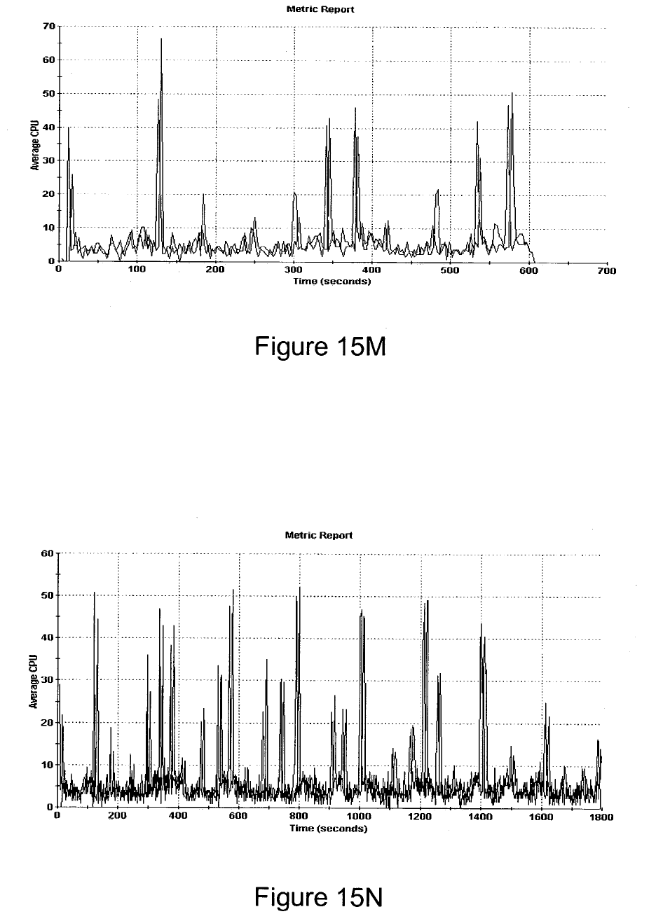

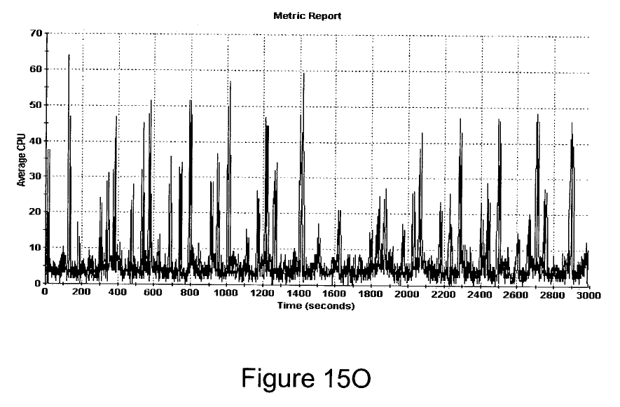

FIGS. 15A-15O are graphs showing experimentally-measured performance accuracy data. Each graph shows the value of a particular system performance metric, either throughput or CPU utilization, at both data recording time (shown in red) and playback time (shown in green). These figures demonstrate the performance accuracy of the playback for different loads (i.e., different numbers of users), different tiers of the N-tiered system (front end processor 26 and applications server 34) and different periods of time.

The performance accuracy of the system at differing loads is demonstrated by recording both throughput and CPU utilization for a typical application over a 10 minute period. The performance accuracy, for throughput, of the recorded and played back workload is in a range of approximately 0% to 5% accuracy for 20 users (FIG. 15C), 50 users (FIG. 15B) and 100 users (FIG. 15A). For the front end processor 26 tier, the performance accuracy of CPU utilization is in a range of approximately 0% to 15% for 20 users (FIG. 15F), 50 users (FIG. 15E) and 100 users (FIG. 15D). For the applications server 34 tier, the performance accuracy of CPU utilization is in a range of approximately 0% to 15% for 20 users (FIG. 151), 50 users (FIG. 15H) and 100 users (FIG. 15G).

The performance accuracy of the system at a 50-user load is demonstrated by recording both throughput and CPU utilization for a typical application, recorded over several time periods. The throughput accuracy is approximately in the range of 0% to 5% for a capture or playback time of 10 minutes (FIG. 15J), 30 minutes (FIG. 15K), and 50 minutes (FIG. 15L). The CPU utilization accuracy, for the applications server 34 tier, is approximately in the range of 0% to 10% for a capture or playback time of 10 minutes (FIG. 15M), 30 minutes (FIG. 15N), and 50 minutes (FIG. 15O).

Error Processing

In some embodiments, the data recording and playback system has the capabilities to trap, parse, identify and process errors received from the system under test 10. In some embodiments, the data recording and playback system uses one or more user-defined handlers to trap, parse, identify and process errors. The handlers can be defined in any suitable language and may be part of the playback agent 14. When an error is returned rather than the expected response, the error handler is invoked to process the error. In some cases, the error information may be displayed on the UI 44. An operator can use this information to determine if a problem exists with the playback.

Examples of errors that may be encountered during a playback session include:

1. Errors arising from the absence of an application or specific data, which may occur if the system under test 10 is not identical or does not have the same services available as the live production system;

2. Error arising from a login or other session initiation failure;

3. A timeout or other event interrupting normal processing; and

4. Errors arising from the normal processing of requests (e.g., account balance below zero, item not in inventory, etc.).

Once an error has been trapped, parsed and identified, the data recording and playback system can take any one of several possible actions. Some examples of possible actions include:

1. Cease processing the current request and continue to playback the other requests in a session, and which is typically done if the error is of a minor nature;

2. Cease processing the current unit of work and continue to playback the other units of work in a session (assuming a session is comprised of several units of work, and each unit of work typically being comprised of multiple related requests), and which is typically done if the error affects the related requests, but not other units of work;

3. Cease processing the session and continue to playback other sessions in the workload, and which is typically done if the error makes processing the rest of the session impossible; and

4. Cease processing the workload, and which is typically done when either fatal errors are encountered or the number and types of errors exceeds predetermined thresholds.

### CONCLUSION

It will be appreciated by those skilled in the art that the above-described system may be straightforwardly adapted or extended in various ways. While the foregoing description makes reference to preferred embodiments, the scope of the invention is defined solely by the claims that follow and the elements recited therein.

We claim:

1. A method for playing back live workload data in a N-tiered computing system consisting of one or more distinct computer systems, a group of one or more application programs each executing in one of the tiers of the N-tiered computing system, comprising:
retrieving live workload data identifying a set of recorded requests and their arguments, each request of the set having been received during an earlier recording period in a particular order by a specified application program among the group of application programs; and
presenting each request identified by the retrieved live workload data to the specified application with its arguments in order to play back the requests identified by the retrieved live workload data, such that the played-back requests are presented in the same order as the recorded requests were received during the recording period, and with arguments corresponding to the arguments with which the recorded requests were received during the recording period, in order to preserve the semantic correctness of the application and preserve the performance accuracy of the N-tiered system in which the identified requests were received.

2. The method of claim 1 wherein the identified requests are presented with the same argument values with which the recorded requests were received during the recording period.

3. The method of claim 1 wherein at least one of the arguments presented with one of the identified requests is presented with a parameterized value.

4. The method of claim 1 wherein at least one application program in the group of application programs is a Java language application, and wherein the identified requests are presented to the Java language application via internal playback.

5. The method of claim 1, further comprising:
retrieving characteristics of the of the N-tiered computing system at the that were captured at the beginning of the recording period; and
before presenting any of the identified requests, modifying the current state of the N-tiered computing system to match the retrieved characteristics of the state of the N-tiered computing system that were captured at the beginning of the recording period.

6. The method of claim 1 wherein a database is accessible to one or more of the application programs in the group of application programs, the method further comprising:
retrieving characteristics of the state of the database that were captured at the beginning of the recording period; and
before presenting any of the identified requests, modifying the current state of the database to match the retrieved characteristics of the state of the database that were captured at the beginning of the recording period.

7. The method of claim 1, further comprising:
retrieving characteristics of the state of the N-tiered computing system that were captured during the recording period; and
during playback, before presenting a selected one of the identified requests, modifying the current state of the N-tiered computing system to match the retrieved characteristics of the state of the N-tiered computing system that were captured during the recording period.

8. The method of claim 1 wherein a selected one of the application programs in the group of application programs has a dynamic state that changed during the recording period, the method further comprising:
retrieving characteristics of the dynamic state of the selected application program that were captured at a time during the recording period after the dynamic state changed; and
during playback, before presenting a selected one of the identified requests, modifying the current state of the selected application program to match the retrieved characteristics of the dynamic state of the selected application program that were captured at a time during the recording period after the dynamic state changed.

9. The method of claim 1 wherein at least one application program in the group of application programs is executing in an HTTP layer, and wherein the identified requests are presented to the application programs executing in the HTTP layer via external playback.

10. A computer-readable medium whose contents cause a computing system to play back live workload data in a N-tiered computing system consisting of one or more distinct computer systems, a group of one or more application programs each executing in one of the tiers of the N-tiered computing system, by:
retrieving live workload data identifying a set of recorded requests and their arguments, each request of the set having been received during an earlier recording period in a particular order by a specified application program among the group of application programs; and
presenting each request identified by the retrieved live workload data to the specified application with its arguments in order to play back the requests identified by the retrieved live workload data, such that the played-back requests are presented in the same order as the recorded requests were received during the recording period, and with arguments corresponding to the arguments with which the recorded requests were received during the recording period, in order to preserve the semantic correctness of the application and preserve the performance accuracy of the N-tiered system in which the identified requests were received.

11. An N-tiered computing system for playing back live workload data, the N-tiered computing system consisting of one or more distinct computer systems, a group of one or more application programs each executing in one of the tiers of the N-tiered computing system, comprising:
a storage device from which live workload data identifying a set of recorded requests and their arguments is retrieved, each request of the set having been received during an earlier recording period in a particular order by a specified application program among the group of application programs; and
a request presentation subsystem that presents each request identified by the live workload data retrieved from the storage device to the specified application with its arguments in order to play back the requests identified by the retrieved live workload data,
such that the played-back requests are presented in the same order as the recorded requests were received during the recording period, and with arguments corresponding to the arguments with which the recorded requests were received during the recording period, in order to preserve the semantic correctness of the application and preserve the performance accuracy of the N-tiered system in which the identified requests were received.

12. A method for playing back live workload data in a N-tiered computing system consisting of one or more distinct computer systems, a group of one or more application programs each executing in one of the tiers of the N-tiered computing system, comprising:
retrieving live workload data identifying a set of recorded requests and their arguments, each request of the set having been received during an earlier recording period in a particular order by a specified application program among the group of application programs; and
presenting each request identified by the retrieved live workload data to the specified application with its arguments in order to play back the requests identified by the retrieved live workload data, such that the identified requests are presented in a manner that varies a run-time characteristic of the request presentation that was present in the receipt of the requests during the recording period,
and such that the played-back requests are presented in the same order as the recorded requests were received during the recording period, and with arguments corresponding to the arguments with which the recorded requests were received during the recording period, in order to preserve the semantic correctness of the application.

13. The method of claim 12 wherein the run-time characteristic that is varied in the presentation of the requests is the timing of presenting the requests.

14. The method of claim 12 wherein the run-time characteristic that is varied in the presentation of the requests is the concurrency of the presented requests.

15. A computer-readable medium whose contents cause a computing system to play back live workload data in a N-tiered computing system consisting of one or more distinct computer systems, a group of one or more application programs each executing in one of the tiers of the N-tiered computing system, by:
retrieving live workload data identifying a set of recorded requests and their arguments, each request of the set having been received during an earlier recording period in a particular order by a specified application program among the group of application programs; and
presenting each request identified by the retrieved live workload data to the specified application with its arguments in order to play back the requests identified by the retrieved live workload data,
such that the identified requests are presented in a manner that varies a run-time characteristic of the request presentation that was present in the receipt of the requests during the recording period,
and such that the played-back requests are presented in the same order as the recorded requests were received during the recording period, and with arguments corresponding to the arguments with which the recorded requests were received during the recording period, in order to preserve the semantic correctness of the application.

16. An N-tiered computing system for playing back live workload data, the N-tiered computing system consisting of one or more distinct computer systems, a group of one or more application programs each executing in one of the tiers of the N-tiered computing system, comprising:
a storage device from which live workload data identifying a set of recorded requests and their arguments is retrieved, each request of the set having been received during an earlier recording period in a particular order by a specified application program among the group of application programs; and
a request presentation subsystem that presents each request identified by the live workload data retrieved from the storage device to the specified application with its arguments in order to play back the requests identified by the retrieved live workload data,
such that the identified requests are presented in a manner that varies a run-time characteristic of the request presentation that was present in the receipt of the requests during the recording period,
and such that the played-back requests are presented in the same order as the recorded requests were received during the recording period, and with arguments corresponding to the arguments with which the recorded requests were received during the recording period, in order to preserve the semantic correctness of the application.

17. A method in a computing system for performing on a subject computer system activities specified by stored information, the subject computer system having performance characteristics including response time, data throughput rate, and processor utilization, the method comprising:
retrieving information specifying activities to perform on the subject computer system; and
performing the specified activities on the subject computer system in accordance with the retrieved information,
such that that the collecting and storing reduce the subject computer system's data throughput rate by no more than 5% over a sampling period during the time over which the activities specified by stored information are performed on the subject computer system, and
such that that the collecting and storing increase the subject computer system's processor utilization by no more than 15% over a sampling period during the time over which the activities specified by stored information are performed on the subject computer system.

18. The method in claim 17 wherein the retrieved information is a live workload characterization of the activities.

19. The method in claim 17 wherein the retrieved information is a live workload characterization of the activities that was constructed in the subject computer system.

20. The method of claim 17 wherein the sampling period is ten minutes.

21. The method of claim 17 wherein the sampling period is the entire period of time over which the activities specified by stored information are performed on the subject computer system.

22. One or more computer memories collectively containing a queue battery data structure for use in playing back a real workload in an N-tiered system, the queue battery comprising a plurality of request queues, each request queue containing an ordered sequence of requests recorded as part of the real workload,
such that requests in the request queues may be dequeued and each presented to the appropriate tier of the N-tiered system in order to play back the real workload.

23. A system for recording data describing live requests and using the recorded data to play back the live requests, comprising:
an N-tiered computing system in which requests are received and processed;
instrumentation installed on the N-tiered computer system that captures live requests received in the computing system during a recording period; and
a storage device that receives from the instrumentation data describing the live requests captured by the instrumentation during the recording period, and that stores the data received from the instrumentation, and that at a later time retrieves the stored data delivers it to the instrumentation,
and wherein the instrumentation receives the data delivered from the storage device and uses the received data to present the live requests described in the data received from the storage device to the N-tiered computing system for processing during a replay period.

24. The system of claim 23, further comprising a processing subsystem that processes the data describing the live requests stored by the storage device to prepare the requests described by the data for presentation during the replay period.

25. The system of claim 23 wherein the live requests captured by the instrumentation and described in the data stored by the storage device includes multiple concurrent requests.

26. The system of claim 23 wherein the data describing the live requests stored by the storage device includes arguments received with the live requests.
